(19) United States
(12) Patent Application Publication
(10) Pub. No.: US 2017/0115437 A1
(43) Pub. Date: Apr. 27, 2017

(54) OPTICAL DEVICE, SUN SCREENING APPARATUS, FITTING, WINDOW MATERIAL, AND METHOD OF PRODUCING OPTICAL DEVICE

(71) Applicant: DEXERIALS CORPORATION, Tokyo (JP)

(72) Inventor: Hiroyuki ITO, Miyagi (JP)

(73) Assignee: DEXERIALS CORPORATION, Tokyo (JP)

(21) Appl. No.: 15/228,064

(22) Filed: Aug. 4, 2016

Related U.S. Application Data
(63) Continuation of application No. 13/023,859, filed on Feb. 9, 2011, now abandoned.

(30) Foreign Application Priority Data
Feb. 12, 2010 (JP) 2010-028411
Mar. 15, 2010 (JP) 2010-056938

(51) Int. Cl. G02B 5/28; E06B 5/18; E06B 9/38; B29D 11/00; G02B 5/04

(52) U.S. Cl. CPC G02B 5/282; B29D 11/0073; G02B 5/045; E06B 9/38; E06B 5/18; B29K 2667/003

(57) ABSTRACT

An optical device includes a shaped layer, an optical function layer, and an embedding resin layer. The shaped layer has a structure forming a concave section. The optical function layer is formed on the structure, and partially reflects incident light. The embedding resin layer is made of energy beam curable resin, the embedding resin layer having a first layer having a first volume, and a second layer formed on the first layer, the second layer having a second volume, the concave section being filled with the first layer, a ratio of the second volume to the first volume being equal to or larger than 5%, the structure and the optical function layer being embedded in the embedding resin layer. In the optical device, at least one of the shaped layer and the embedding resin layer has light transmissive property, and an entrance surface for the incident light.

### CROSS REFERENCES TO RELATED APPLICATIONS

The present application is a continuation application of U.S. patent application Ser. No. 13/023,859 filed Feb. 9, 2011, which claims priority to Japanese Patent Application JP 2010-028411 filed in the Japan Patent Office on Feb. 12, 2010 and Japanese Patent Application JP 2010-056938 filed in the Japan Patent Office on Mar. 15, 2010, the entire contents of which are hereby incorporated by reference.

### BACKGROUND

The present application relates to an optical device configured to partially reflect incident light, for example, an optical device configured to have visible part of incident light passed therethrough, and to reflect infrared part of incident light in a specific direction, a sun-screening apparatus provided with the optical device, a fitting provided with the optical device, a window material provided with the optical device, and a method of manufacturing the optical device.

In recent years, there have been increasing the number of cases in which architectural window glass of high-rise buildings, residential house and the like, and vehicular glass are provided with a layer configured to partially absorb or reflect sunlight. This structure, provided as one of energy efficiency measures for preventing global warming, can reduce load of air conditioner by suppressing the rise of room temperature resulting from light energy passing through the window from the sun.

As one example of the structure configured to screen near-infrared light while maintaining a light transmissive property in the range of visible light, there are known a layer having a high reflection factor in the range of near-infrared light is provided on a window glass (see International Patent Application Laid-Open Publication No. WO2005/087680), and a layer having a high absorption factor in the range of near-infrared light is provided on a window glass (see Japanese Patent Application Laid-Open Publication No. H06-299139) are provided on a window glass. As another example, a transmissive wavelength-selective recursive reflector is used for a traffic sign or the like, not for a window glass. This recursive reflector is configured to have an optical structure layer to recursively reflect light in a specific wavelength range while having visible light passed therethrough (see Japanese Patent Application Laid-Open Publication No. 2007-10893). This recursive reflector is configured to have an optical structure layer having a recursive reflection structure, a wavelength selective reflection layer formed along the recursive reflection structure, and an optically-transmissive resin layer in which the recursive reflection structure is embedded. The optically-transmissive resin layer is formed of, for example, an energy beam curable resin.

### SUMMARY

However, the structure disclosed in Japanese Patent Application Laid-Open Publication No. 2007-10893 cannot reduce residual stress after the energy beam curable resin is cured. Therefore, the structure tends to cause deterioration in transmittance of the optical device from delamination between the wavelength selective reflection layer formed along the recursive reflection structure and the optically-transmissive resin layer in which the recursive reflection structure is embedded.

In view of the circumstances as described above, it is possible to provide an optical device that suppresses the rise of surrounding temperature by partially reflecting incident light, and has high quality in durability without delamination, a sun-screening apparatus, a fitting, a window material, and a method of manufacturing the optical device.

According to an embodiment, there is provided an optical device including a shaped layer, an optical function layer, and an embedding resin layer.

The shaped layer has a structure forming a concave section.

The optical function layer is formed on the structure, and configured to partially reflect incident light.

The embedding resin layer is made of energy beam curable resin. The embedding resin layer is configured to have a first layer having a first volume, and a second layer formed on the first layer. The second layer has a second volume. The concave section is filled with the first layer, a ratio of the second volume to the first volume being equal to or larger than 5%. The structure and the optical function layer are embedded in the embedding resin layer.

At least one of the shaped layer and the embedding resin layer has light transmissive property, and an entrance surface for the incident light.

In the above optical device, the optical function layer is configured to partially reflect incident light passed into the structure through the entrance surface. The structure forms a concave section on the surface of the shaped layer. The optical function layer formed on the structure is configured to reflect light in an incident direction. Therefore, it is possible to suppress the rise of surrounding temperature in comparison with regular reflection, by reason that the optical function layer is designed to reflect inferred light. Further, it is possible to have a high level in visibility, and let in light while suppressing the rise of surrounding temperature, by reason that the optical function layer is designed to have visible light passed therethrough.

In the above optical device, the embedding resin layer can prevent the structure and the optical function layer from damage and defacement, and enhance quality in durability, by reason that the embedding resin layer is configured to function as a layer for protecting the structure and the optical function layer. The second layer can reduce residual stress when the energy beam curable resin is cured, and prevent transmittance of the optical device from being lowered due to delamination between the optical function layer and the first layer over a long period of time, by reason that the embedding resin layer is configured to have a first layer with which the concave section is filled, the first layer having a first volume, and a second layer formed on the first layer, the second layer having a second volume and a function of connecting the first layers to each other, a ratio of the second volume to the first volume being equal to or larger than 5%.

The structure is not limited in shape, and may have a shape of prism, cylinder, hemisphere, or corner of a cube, or the like.

The energy beam curable resin is typically made of ultraviolet resin. On the other hand, the energy beam curable resin may be made of resin which is curable in response to electron beam, X-ray, infrared light, or visible light. The shaped layer may be made of energy beam curable resin, or other material such as thermoplastic resin, and thermo-setting resin.

The optical device may be formed into film, sheet, or block, and may be attached to an interior or exterior trim or window for architecture or automotive vehicle.

When the ratio of the second volume to the first volume is smaller than 5%, it may be difficult to reduce residual resin of the energy beam curable resin by the second layer. Therefore, it may be difficult to prevent the delamination between the first layer and the optical function layer over a long period of time. The second volume is determined on the basis of shrinkage stress of the energy beam curable resin. It is preferable that the energy beam curable resin be equal in cure shrinkage ratio to or larger than 3% in volume.

When the energy beam curable resin has a cure shrinkage ratio equal to or larger than 8% in volume, a ratio of the second volume to the first volume may be equal to or larger than 15% in volume. When the energy beam curable resin has a cure shrinkage ratio equal to or larger than 13% in volume, the ratio of the second volume to the first volume may be equal to or larger than 50%. When the energy beam curable resin is cured, it possible to prevent delamination between the optical function layer and the first layer.

The optical device may further include a base member formed on at least one of the shaped layer and the embedding resin layer, the base member being light-transmissive property.

It is possible to enhance protection effect for the structure and optical function layer, and to have high productivity.

According to an embodiment, there is provided a window material including a first supporting member, an optical function layer, a second supporting member, and a window unit.

The first supporting member is configured to have a structure forming a concave section.

The optical function layer is formed on the structure, and configured to partially reflect incident light.

The second supporting member is made of energy beam curable resin. The second supporting member is configured to have a first layer having a first volume, and a second layer formed on the first layer. The second layer is configured to have a second volume. The concave section is filled with the first layer. A ratio of the second volume to the first volume is equal to or larger than 5%. The structure and the optical function layer are embedded in the second supporting member.

The window unit is connected to the second supporting member.

The above window material has a high level in visibility, and is configured to let in light while suppressing the rise of surrounding temperature, and to prevent delamination between the optical function layer and the first layer over a long period of time, and has a high quality in durability, by reason that the optical function layer is designed to reflect infrared light, and to have visible light passed therethrough.

According to an embodiment, there is provided a manufacturing method for an optical device, the method including forming a first supporting member configured to have a structure forming a concave section. An optical function layer configured to partially reflect incident light is formed on the structure. A second supporting member is formed by embedding the structure and the optical function layer in energy beam curable resin, and configured to have a first layer having a first volume, and a second layer formed on the first layer, the second layer having a second volume, the concave section being filled with the first layer, a ratio of the second volume to the first volume being equal to or larger than 5%.

Additional features and advantages are described herein, and will be apparent from the following Detailed Description and the figures.

### BRIEF DESCRIPTION OF THE FIGURES

FIG. 1 is a cross-sectional view schematically showing a configuration of an optical device and a heat reflecting window provided with this device according to one embodiment;

FIG. 2 is a fragmentary perspective view showing one example of a configuration of a shaped layer of the optical device;

FIG. 3 is a fragmentary perspective view showing another example of the configuration of the shaped layer of the optical device;

FIG. 4 is a fragmentary plan view showing further example of the configuration of the shaped layer of the optical device;

FIG. 5 is a cross-sectional view for explaining a main part of an embedding resin layer of the optical device;

FIG. 6 is a cross-sectional view for explaining an operation of the optical device;

FIGS. 7A, 7B and 7C are cross-sectional views for explaining steps of a manufacturing method for the optical device according to the embodiment;

FIGS. 8A, 8B and 8C are cross-sectional views for explaining steps of the manufacturing method for the optical device according to the embodiment;

FIG. 9 is a schematic view showing a configuration of a manufacturing apparatus for the optical device according to the embodiment;

FIG. 10 is a plan view showing a main part of the manufacturing apparatus shown in FIG. 9;

FIG. 11 is a cross-sectional view schematically showing an example of a configuration of a main part of a mold tool configured to manufacture the shaped layer;

FIG. 12 is a graph showing a relationship between volume ratio of a flat layer of the embedding resin layer and transmittance change of the optical device subjected to a high-temperature and high-humidity test, which will be explained in examples of the present application;

FIG. 13 is a perspective view showing a relationship between light incident on the optical device and light reflected from the optical device, which will be explained in a modified example of the present application;

FIG. 14 is a cross-sectional view showing an example of a configuration of the optical device according to a modified example of the present application;

FIG. 15 is a perspective view showing an example of a configuration of structures of the optical device according to the modified example of the present application;

FIG. 16A is a perspective view showing an example of a shape of structures formed in the shaped layer of the optical device according to a modified example of the present application;

FIG. 16B is a cross-sectional view showing a direction of inclination of a main axis of the structures formed in the shaped layer of the optical device according to the modified example of the present application;

FIG. 17 is a cross-sectional view showing an example of a configuration of the optical device according to a modified example of the present application;

FIGS. 18A, 18B and 18C are cross-sectional views each showing another example of a configuration of the optical device according to a modified example of the present application;

FIG. 19 is a cross-sectional view showing further example of a configuration of the optical device according to a modified example of the present application;

FIGS. 20A and 20B are perspective views, each of which shows an example of a configuration of the shaped layer of the optical device according to a modified example of the present application;

FIG. 21A is a plan view showing another example of the configuration of the shaped layer of the optical device according to the modified example of the present application;

FIG. 21B is a cross-sectional view of the shaped layer shown in FIG. 21A along a line B-B′;

FIG. 21C is a cross-sectional view of the shaped layer shown in FIG. 21A along a line C-C′;

FIG. 22A is a plan view showing further example of the configuration of the shaped layer of the optical device according to the modified example of the present application;

FIG. 22B is a cross-sectional view of the shaped layer shown in FIG. 22A along a line B-B′;

FIG. 22C is a cross-sectional view of the shaped layer shown in FIG. 22A along a line C-C′;

FIG. 23 is a perspective view showing an example of a configuration of a window shade apparatus according to an application example of the present application;

FIG. 24A is a cross-sectional view showing a main part of the window shade according to the application example of the present application;

FIG. 24B is a cross-sectional view showing a main part of the window shade according to the modified example of FIG. 24A;

FIG. 25A is a perspective view showing an example of a configuration of a roll screen apparatus according to an application example of the present application;

FIG. 25B is a cross-sectional view showing a main part of the pull-down sun screening apparatus of FIG. 25A;

FIG. 26A is a perspective view showing an example of a configuration of a fitting according to an application example of the present application; and

FIG. 26B is a cross-sectional view showing a main part of the fitting of FIG. 26A.

### DETAILED DESCRIPTION

Embodiments of the present application will be described below in detail with reference to the drawings.

Configuration of the Optical device

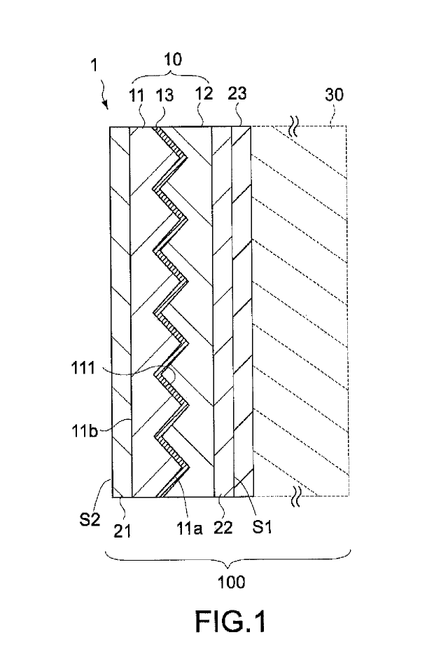

FIG. 1 is a cross-sectional view schematically showing a configuration of an optical device according to one embodiment. In this embodiment, the optical device 1 includes a laminated body 10 having a shaped layer (first supporting member) 11, an embedding resin layer (second supporting member) 12, and an optical function layer 13 formed between the shaped layer 11 and the embedding resin layer 12. The optical device 1 further includes a first base member 21 located on the shaped layer 11 and a second base member 22 located on the embedding resin layer 12, the first and second base members 21 and 22 being respectively made of transmissive materials. The optical device 1 is attached to a window unit 30 of an automotive vehicle or a building through a connecting layer 23 formed on the second base member 22.

Each part of the optical device 1 will then be described hereinafter in detail.

Shaped Layer

The shaped layer 11 is made of, for example, thermoplastic resin such as polycarbonate, thermosetting resin such as epoxies, ultraviolet curable resin such as acrylic, or other transmissive resin material. In this embodiment, the shaped layer 11 is made of ultraviolet curable resin, and similar in material to an embedding resin layer 12 to be described hereinafter. The shaped layer 11 has a function to support the optical function layer 13 as a supporting member, and is formed into film, sheet, plate, or square, which is previously determined in thickness.

The shaped layer 11 has a plurality of structures 11a forming a plurality of concave sections 111 arranged on a surface on which the optical function layer 13 is formed. The shaped layer 11 has a flat surface 11b on the side opposite to the structures 11a.

In this embodiment, each of the concave sections 111 has a shape which reflects light in a specific direction, and which is, for example, pyramid, cone, rectangular cylinder, curved surface, or the like. The concave sections 111 are the same as each other in shape and size. However, the concave sections 111 may be divided into areas which differ from each other in shape and size, or periodically changed in shape and size.

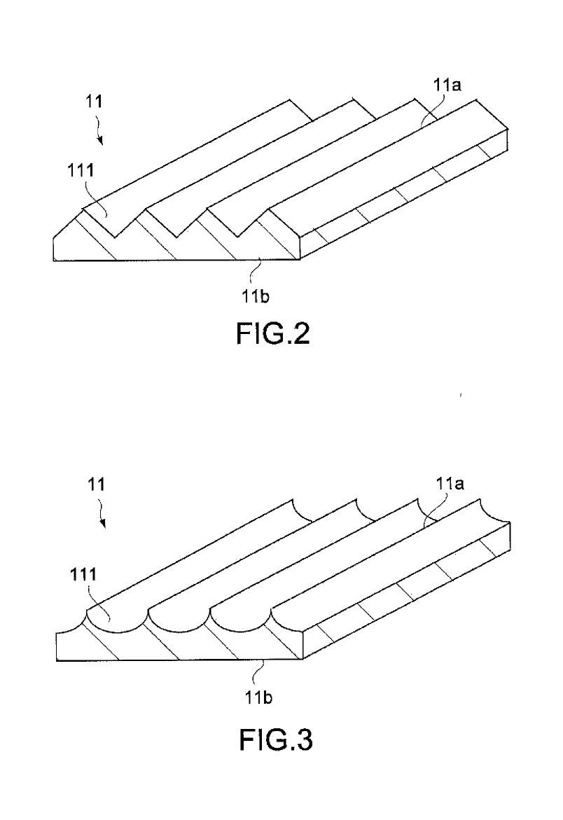

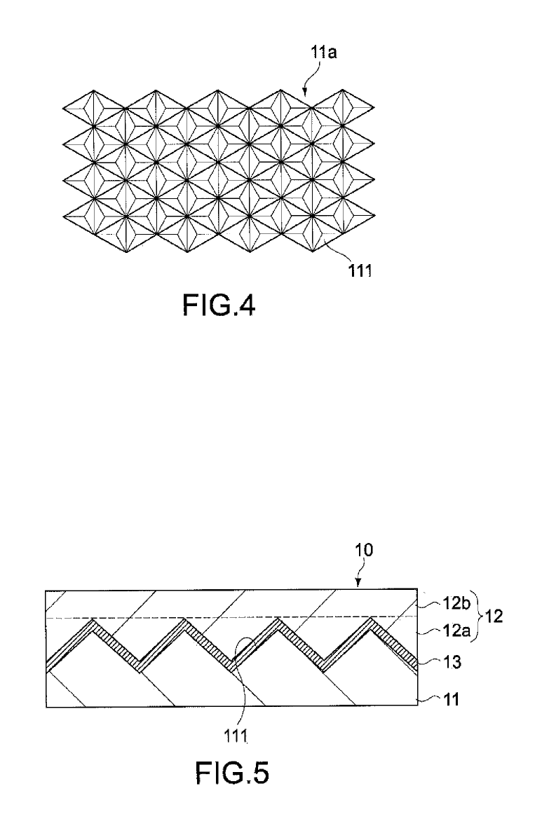

FIG. 2 is a fragmentary perspective view showing a shaped layer 11 having structures 11a of one dimensional array forming concave sections 111, each of which has a shape of triangular prism (shape of prism). FIG. 3 is a fragmentary perspective view showing a shaped layer 11 having structures 11a of one dimensional array forming concave sections 111, each of which has a curved surface (shape of cylindrical lens). FIG. 4 is a fragmentary plan view showing a shaped layer 11 having structures 11a of two dimensional arrays forming concave sections 111, each of which has a shape of triangular pyramid (shape of delta dense array). However, the concave sections 111 (or the structures 11a) is not limited in shape, and may be formed into different shapes such as corner of a cube, hemisphere, oval hemisphere, free-form surface, polygon, circular corn, many-sided pyramid, circular truncated cone, paraboloidal surface, concave, and convex. The bottom surface of the concave sections 111 may have a polygonal shape such as circle, ellipse, triangle, square, hexagon, and octagon.

A pitch of the structures 11a (concave section 111) (i.e., distance between two peaks of concave sections 111 adjacent to each other) is not limited to a specific value, and may be selectable from tens of μm to hundreds of μm as necessary. It is preferable that the pitch of the structures 11a be equal to or larger than 5 μm, and equal to or smaller than 5 mm. As another preferable range, the pitch of the structures 11a may be equal to or larger than 5 μm, and smaller than 250 μm. As further preferable range, the pitch of the structures 11a may be equal to or larger than 20 μm, and equal to or smaller than 200 μm. On the other hand, under the condition that the pitch of the structures 11a is smaller than 5 μm, it is difficult to form concave sections 111, each of which has a desired shape. Further, it is generally difficult to allow an optical function layer to have a precipitous wavelength-selective characteristic. In some cases, the optical function layer tends to improperly reflect part of light to be passed through this device. As a result, higher-order visible light is generated through this refraction. When, on the other hand, each of the concave sections 111 has a shape necessary to reflect light in a designated direction, the optical device 1 becomes less flexible due to the increased thickness. It is difficult to attach this optical device to a rigid object such as the window unit 30. When the pitch of the structures 11a is equal to or larger than 5 μm, and smaller than 250 μm, the optical device 1 is improved in flexibility, and can be produced with ease by roll-to-roll production system, without batch production system. In order to apply the optical device to architectural material such as window, it is necessary to produce the few-meter-long optical device. Therefore, the roll-to-roll production system is suitable for the production of the optical device in comparison with the batch production system. Specifically, the roll-to-roll production system does not limit the depth of the concave section 111. For example, the depth of the concave section 111 may be determined within the equal to or larger than 10 μm, and equal to or smaller than 100 μm. The aspect ratio (depth and square) of the concave section 111 may be equal to or larger than 0.5.

Optical Function Layer

The optical function layer 13 is formed on the structures 11a of the shaped layer 11. The optical function layer 13 is a wavelength-selective reflection layer including an optical multilayer film configured to reflect light in a specific wavelength range (first wavelength range), and to have light passed therethrough in a range (second wavelength range) other than the specific wavelength range. In this embodiment, the term “specific wavelength range” means an infrared wavelength range including a near-infrared wavelength range, and the term “range other than the specific wavelength range” means a visible light range.

The optical function layer 13 is formed with alternating layers of, for example, a first refraction index layer (low refraction index layer) and a second refraction index layer (high refraction index layer) which is larger than the first refraction index layer in refraction index. On the other hand, the optical function layer 13 may be formed with alternating layers of a metal layer and an optically-transmissive layer (or transmissive conductive layer). The metal layer has a high reflection rate in an infrared range, while the optically-transmissive layer functions as an antireflection layer, and has a high refraction index in a visible range.

The metal layer having a high reflection rate in an infrared range includes a single element such as Au, Ag, Cu, Al, Ni, Cr, Ti, Pd, Co, Si, Ta, W, Mo, and Ge, or an alloy made mostly of two or more elements. More specifically, AlCu, AlTi, AlCr, AlCo, AlNdCu, AlMgCu, AgBi, AgPdCu, AgPdTi, AgCuTi, AgPdCa, AgPdMg, AgPdFe or the like may be used as material of the metal layer. The optically-transmissive layer is made mostly of high-permittivity material such as niobium oxide, tantalum oxide, or titanium oxide. The optically-transmissive layer may be made mostly of, for example, tin oxide, zinc oxide, indium-doped tin oxide, material containing carbon nanotubes, indium-doped zinc oxide, antimony-doped tin oxide, or a layer made of resin which has high levels of nanoparticle having those materials, nanoparticle having conductive material such as metal, nanoparticle, nanorod, or nanowire.

Additionally, the optically-transmissive layer or transmissive conductive layer may have a dopant such as Al and Ga for the purpose of improving the quality and flatness of those layers under the condition that the metal oxide layer is formed on the basis of a sputtering method or the like. For example, Ga and Al doped zinc oxide (GAZO), Al doped zinc oxide (AZO), or Ga doped zinc oxide can be selectively used for the metal oxide layer made of zinc oxide series.

It is preferable that the refraction index of the high refraction index layer contained in the laminated body be equal to or larger than 1.7, and equal to or smaller than 2.6. As another preferable refraction index, the refraction index of the high refraction index layer may be equal to or larger than 1.8, and equal to or smaller than 2.6. As further preferable refraction index, the refraction index of the high refraction index layer may be equal to or larger than 1.9, and equal to or smaller than 2.6. In this range, the high refraction index layer can be formed as a thin film without crack, and function as antireflection film in visible range. Here, this refraction index indicates a refraction index measured at a wavelength of 550 nm. The high refraction index layer is a layer made mostly of metal oxide. In terms of suppressing stress of this layer, and reducing the incidence of clack, sometimes it is preferable that the high refraction index layer be made of metal oxide other than zinc oxide. Specifically, it is preferable to use at least one of niobium oxide (for example, niobium pentoxide), tantalum oxide (for example, tantalum pentoxide), and titan oxide. It is preferable that the thickness of the high refraction index layer be equal to or larger than 10 nm, and equal to or smaller than 120 nm. As further preferable thickness, the thickness of the high refraction index layer may be equal to or larger than 10 nm, and equal to or smaller than 100 nm. As further preferable thickness, the thickness of the high refraction index layer may be equal to or larger than 10 nm, and equal to or smaller than 80 nm. When, on the other hand, the thickness of the high refraction index layer is smaller than 10 nm, the high refraction index layer tends to reflect visible light. When the thickness of the high refraction index layer is larger than 120 nm, the high refraction index layer is reduced in transmittance, and tends to make it easier to have clack.

The optical function layer 13 is not limited to a multiple layer made of inorganic material. For example, the optical function layer 13 may be composed of a thin film made of high-polymer material, or a laminated film of layers made of high-polymer material having scattered fine particles or the like. The optical function layer 13 is not limited in thickness to a specific value, but necessary to reflect light in a specific range with a specific efficiency in reflectance. For example, dry process such as sputtering method and vacuum vapor deposition method, or wet process such as dip coating method and die coating method is used as a method of forming an optical function layer 13. The optical function layer 13 to be formed on the structures 11a is substantially uniform in thickness. Additionally, it is preferable that the average thickness of the optical function layer 13 be equal to or smaller than 20 μm. As another preferable range, the average thickness of the optical function layer 13 may be equal to or smaller than 5 μm. As further preferable range, the average thickness of the optical function layer 13 may be equal to or smaller than 1 μm. When, on the other hand, the average thickness of the optical function layer 13 is larger than 20 μm, the light path of transmitted light is increased, and inclined to stress an image of the transmitted light.

The optical function layer 13 may have one or more functional layers composed mostly of chromic material which reversibly changes in reflective performance, structure and the like in response to external stimulation such as heat, light, and invading molecule. The optical function layer 13 may be combined with the laminated film and transmissive conductive layer. For example, as chromic material, photo-chromic, thermo-chromic, gas-chromic, or electro-chromic material may be used for the optical function layer 13.

The term “photo-chromic material” means material which reversibly changes in structure with light. The photo-chromic material can reversibly change in various properties such as reflection rate and color while being subjected to ultraviolet light. For example, “Cr”, “Fe”, “Ni” or the like doped TiO₂, WO₃, MoO₃, Nb₂O₅ or other transition metal compound may be used as photo-chromic material. In order to improve wavelength-selective characteristic of the optical function layer 13, a layer different in refraction index from the optical function layer 13 may be formed on this layer.

The term “thermochromic material” means material which reversibly changes in structure with heat. The thermochromic material can reversibly change in various properties such as reflection rate and color while being subjected to heat. For example, VO₂ or the like may be used as thermochromic material. Elements such as “W”, “Mo” or “F” may be added to the thermochromic material such as VO₂ for the purpose of changing transition temperature or transition curve. As a laminated structure, a layer made mostly of the thermochromic material such as VO₂ may intervene between two antireflection layers each of which is made mostly of TiO₂, ITO, or other material having high refraction index.

On the other hand, a photonic lattice such as cholesteric liquid crystal is may be used as thermochromic material. The cholesteric liquid crystal can selectively reflects light on the basis of its interlayer spacing which is changed with temperature. Therefore, the cholesteric liquid crystal can reversibly change with heat in various properties such as reflection rate and color while being subjected to heat. Further, two or more cholesteric liquid crystals different in thickness from each other may be used to broaden a reflection range.

The term “electrochromic material” means material which reversibly changes with applied voltage in various properties such as reflection rate and color. For example, the electrochromic material can reversibly change in structure in response to voltage. More specifically, a reflection-type light control material having reflection characteristic which changes with, for example, doped proton or undoped proton can be used as electrochromic material which can be controlled in optical property in response to external stimulus to selectively assume states including a transmissive state, a mirror state, and/or an intermediate state. For example, alloy material consists primarily of alloy material such as magnesium and nickel alloy, magnesium and titanium alloy, and material in which WO₃ and acicular crystal having selective reflectivity are contained in microcapsule may be used as electrochromic material.

As a specific configuration of the optical function layer, for example, the above-mentioned alloy layer, a catalytic layer including Pd and the like, a thin buffer layer of Al and the like, an electrolyte layer of Ta₂O₅ and the like, an ion storage layer such as WO₃ and proton, and a transmissive conductive layer may be stacked in layers on the shaped layer. On the other hand, a transmissive conductive layer, an electrolyte layer, an electrochromic layer of WO₃ and the like, and a transmissive conductive layer may be stacked in layers on the shaped layer. In those configurations, the proton contained in the electrolyte layer is doped or undoped in the alloy layer when voltage is applied between the transmissive conductive and a counter electrode. Accordingly, the transmittance of the alloy layer changes. In order to improve the selectivity in wavelength, it is preferable that the laminating layer be provided with the electrochromic material and high refraction index material such as TiO₂ and ITO. As another configuration, transmissive conductive layer, light transmissive layer in which microcapsules are scattered, and transmissive electrodes may be stacked in layers on the shaped layer. In this configuration, the optical device assumes a transmissive state in which the acicular crystal contained in microcapsules is oriented in the same direction when voltage is applied to two transmissive electrodes, and assumes a wavelength selective reflection state in which the acicular crystal contained in microcapsules is scattered in direction at random without being oriented in the same direction when voltage is not applied to two transmissive electrodes.

Embedding Resin Layer

The embedding resin layer 12 is made of, for example, transmissive ultraviolet curable resin. The structures 11a of the shaped layer 11 and the optical function layer 13 are embedded in the embedding resin layer 12.

For example, the ultraviolet curable resin includes, as composition element, (meta-) acrylate, and photopolymerization initiator. If necessary, the ultraviolet curable resin may further include light stabilizer, fire-retarding material, leveling agent, antioxidizing agent, and the like.

As acrylate, monomer and/or oligomer having two or more (meta-)acryloyl groups may be used. As monomer and/or oligomer, urethane-(meta-)acrylate, epoxy-(meta-)acrylate, polyester-(meta-)acrylate, polyol-(meta-)acrylate, polyether-(meta-)acrylate, melamine-(meta-) acrylate or the like may be used. Here, the term “(meta-)acryloyl group” is intended to indicate either acryloyl group or meta-acryloyl group. The term “oligomer” is intended to indicate a molecule having a molecular weight of 500 to 6000. As “photopolymerization initiator”, for example, benzophenone derivative, acetophenone derivative, anthraquinone derivative and the like may be used as a single agent or in combination.

FIG. 5 is a cross-sectional view schematically showing a configuration of a main part of the embedding resin layer 12. The embedding resin layer 12 has a structured layer 12a (first layer) which the concave sections 111 of the optical function layer 13 are filled with, the structured layer 12a having a triangular shape in cross-section, and a flat layer 12b (second layer) formed on the structured layer 12a. The structured layer 12a is formed in each of the concave sections 111 which constitute the structures 11a. The thickness of the structured layer 12a is equal to the depth of the concave sections 111. The structured layer 12a and the optical function layer 13 formed on the concave sections 111 stick together. The flat layer 12b has a function to have the structured layers 12a connect with each other, and has a flat surface.

The flat layer 12b has a function to suppress delamination resulting from cure shrinkage of ultraviolet curable resin when the embedding resin layer 12 is made of ultraviolet curable resin. In general, when ultraviolet curable resin is subjected to and cured with ultraviolet light, the ultraviolet curable resin shrinks on the basis of an inherent shrinkage factor depending on composition, contained material, and the like of the resin. When the shrinkage stress is not reduced appropriately, the shrinkage stress is focused on the interface between the optical function layer and adjacent layer by heat load or the like to which the resin is subjected. The shrinkage stress tends to cause delamination on this interface and temporarily reduces transmittance of the optical device. Specifically, the adhesion of the resin to a metal layer or a dielectric layer is relatively low. Therefore, the delamination of the resin to the optical function layer tends to occur. In this embodiment, the optical device 1 is configured to have the flat layer 12b. Therefore, it is possible to suppress delamination of the structured layer 12a to the optical function layer 13 by reducing inner stress remaining in the structured layer 12a.

The thickness of the flat layer 12b is determined on the basis of the ratio in cure shrinkage of the resin to be used as the flat layer 12b and the volume of the structured layer 12a. When, for example, the ratio in cure shrinkage of ultraviolet curable resin used as the embedding resin layer 12 is equal to or larger than 3% in volume, the thickness of the flat layer 12b is determined under the condition that the ratio of the volume (second volume) of the structured layer 12a to the volume (first volume) of the structured layer 12a is equal to or larger than 5%. When, on the other hand, the ratio is smaller than 5%, the residual stress of the structured layer 12a may be impossible to be suppressed by the flat layer 12b, and the delamination between the structured layer 12a and the optical function layer 13 may not be controlled over a long period of time.

The thickness of the flat layer 12b is determined on the basis of the ratio in volume of the flat layer 12b and the structured layer 12a (concave section 111). The first volume may be defined by each volume of the concave sections 111 or whole volume of the concave sections 111. In the former case, the second volume is a volume of each unit (corresponding to each forming area of concave sections 111) of the flat layer 12b. In the latter case, the second volume is a whole volume of the flat layer 12b.

If the ultraviolet curable resin has a cure shrinkage ratio equal to or larger than 8% in volume, the ratio of the flat layer 12b to the structured layer 12a may be equal to or larger than 15% in volume. Further, if the ultraviolet curable resin has a cure shrinkage ratio equal to or larger than 13% in volume, the ratio of the flat layer 12b to the structured layer 12a may be equal to or larger than 50% in volume. Therefore, it is possible to suppress delamination between the optical function layer 13 and the structured layer 12a when the ultraviolet curable resin is cured by ultraviolet light.

At least one of the shaped layer 11 and the embedding resin layer 12 is high in transparency. As this transparency, it is preferable that at least one layer have the following range in sharpness of a light-transmissive image of an optical comb. As one preferable range, the difference in refraction index between the shaped layer 11 and the embedding resin layer 12 may be equal to or smaller than 0.010. As another preferable range, the difference in refraction index between the shaped layer 11 and the embedding resin layer 12 may be equal to or smaller than 0.008. As further preferable range, the difference in refraction index between the shaped layer 11 and the embedding resin layer 12 may be equal to or smaller than 0.005. When, for example, the difference in refraction index between the shaped layer 11 and the embedding resin layer 12 is larger than 0.010, the transmission image tends to have a lack in sharpness. When the difference in refraction index between the shaped layer 11 and the embedding resin layer 12 is larger than 0.008 and equal to or smaller than 0.010, the transmission image does not have trouble interfering with one's daily like, and varies according to the situation at the time.

When the difference in refraction index between the shaped layer 11 and the embedding resin layer 12 is larger than 0.005, and equal to or larger than 0.008, the user may be conscious of a diffraction pattern produced in response to an extremely bright object such as light source, but can look out the window in focus. When the difference in refraction index between the shaped layer 11 and the embedding resin layer 12 is equal to or smaller than 0.005, the user is hardly conscious of the diffraction pattern. In the shaped layer 11 or the embedding resin layer 12, the supporting member provided on the side of the window unit 30 or the like may include adhesive as a main element. Therefore, members for fitting the optical device with the window can be reduced. Additionally, it is preferable that the difference in refraction index of the adhesive be within the above range in this configuration.

If both of the shaped layer 11 and the embedding resin layer 12 are high in optical transparency, it is preferable that those layers be made of the same materials which are high in optical transparency in the range of visible light. The shaped layer 11 and the embedding resin layer 12 made of the same material are similar in refraction index to each other. Therefore, the optical device can be improved in optical transparency in the range of visible light. Here, the term “optical transparency” has two aspects. One means that light is passed without being absorbed, while the other means that light is passed without being scattered. In general, the term “optical transparency” tends to mean the former. However, it is preferable that the term “optical transparency” have both meanings in this application. When the optical device 1 according to the embodiment is used as a directional reflector, it is preferable to reflect specific light in a specific direction, and to have passed therethrough light other than specific light, and preferable that light passed through the optical device 1 be substantially passed through the transmissive object to which the optical device is attached, without being scattered, for user looking at the transmitted light. However, one supporting member may be intended to have light scattering property depending on its intended use.

When the shaped layer 11 and the embedding resin layer 12 are made of resin, under the condition that the resin layer (shaped resin layer) formed before the optical function layer is formed, and the resin layer (embedding resin layer) formed after the optical function layer is formed, it is preferable that the resin layer (shaped resin layer) and the resin layer (embedding resin layer) be the same in refraction index as each other. However, when both resin layers are made of the same organic resin, and the optical function layer is made of inorganic resin, and additive agent is added to the shaped resin layer to enhance adhesion of the optical function layer to the resin layers, it is difficult to separate the shaped resin layer from the mold tool of Ni—P at a time when the shape is transferred. When the optical function layer is formed by the sputtering method, high-energy particles adhere to the optical function layer, and there is hardly problem with the adhesion between the shaped resin layer and the optical function layer. Therefore, it is preferable that minimum amounts of additive agent be added to the shaped resin layer, and additive agent for enhancing adhesion be added to the embedding resin layer. When the embedding resin layer and the shaped resin layer are substantially different to a large extent from each other in refraction index, it is difficult to look out the window through the fogged optical device 1. When the amounts of the additive agent is reduced to a specific value equal to or smaller than 1% by mass, the optical device 1 can be improved in transparency sharpness without changing the refraction index. If it is necessary to add the large amount of additive agent, it is preferable to adjust the combination ratio of the shaped resin layer to ensure that the embedding resin layer and the shaped resin layer are substantially the same in refraction index as each other.

From the point of view of industrial design of the optical device 1, window material and the like, it is understood that the shaped layer 11 and/or the embedding resin layer 12 may have characteristic to absorb light in specific wavelength in the range of visible light. As material having characteristic such as this, the shaped layer 11 or the embedding resin layer 12 may be made mostly of material (such as resin) provided with organic or inorganic colorant. Specifically, it is preferable that inorganic colorant be used as material having high resistance to climate conditions, specifically inorganic colorant such as zircon gray (Co and Ni-doped ZrSiO₄), praseodymium yellow (Pr-doped ZrSiO₄), chrome-titan-yellow (Cr and Sb-doped TiO₂, or Cr and W-doped TiO₂), chrome green (Cr₂O₃, and the like), peacock ((CoZn)O(AlCr)₂O₃), victoria green ((Al, Cr)₂O₃), iron blue (CoO.Al₂O₃.SiO₂), vanadium-zircon blue (V-doped ZrSiO₄), chrome-tin pink (Cr-doped CaO, SnO₂, SiO₂), manganese pink (Mn-doped Al₂O₃), salmon pink (Fe-doped ZrSiO₄), and other, organic colorant such as azo-series colorant, and phthalocyanine-series colorant.

First and Second Base Members

As shown in FIG. 1, the laminated body 10 including the shaped layer 11, the embedding resin layer 12, and the optical function layer 13 intervenes between the first and second base members 21 and 22.

Each of the first and second base members 21 and 22 is made of transmissive material such as triacetyl cellulose (TAC), polyester (TPEE), polyethylene terephthalate (PET), polyimide (PI), polyamide (PA), aramid, polyethylene (PE), polyacrylate, polyether sulfone, polysulfone, polypropylene (PP), diacetyl cellulose, polyvinyl chloride, acrylate resin (PMMA), polycarbonate (PC), epoxy resin, urea resin, polyurethane resin, and melamine resin. However, the transmissive material of the first and second base members 21 and 22 is not limited to those materials.

The first and second base members 21 and 22 have functions as a protective layer configured to protect the laminated body 10. The first and second base members 21 and 22 are made of material such as polyethylene terephthalate smaller in moisture vapor transmission rate than ultraviolet curable resin. It is possible to suppress the delamination between the optical function layer 13 and the embedding resin layer 12, due to the fact that the moisture is absorbed by the laminated body 10. Further, the optical device 1 can be reduced in light loss by reflection, and improved in transmittance, due to the fact that the first and second base members 21 and 22 are made of material substantially the same in refraction index as the shaped layer 11 and the embedding resin layer 12. Further, it is easy to produce the shaped layer 11 and the embedding resin layer 12 from ultraviolet resin layer, due to the fact that material has a high transmittance in the range of ultraviolet light.

The first base member 21 is formed as a layer on the flat surface 11b opposite to the structures 11a of the shaped layer 11. The second base member 22 is formed as a layer on the flat surface 12b of the embedding resin layer 12. On the other hand, it is only necessary to provide either the first base member 21 or the second base member 22 as a layer.

Explanation about Optical Device Functioning as Directional Reflector

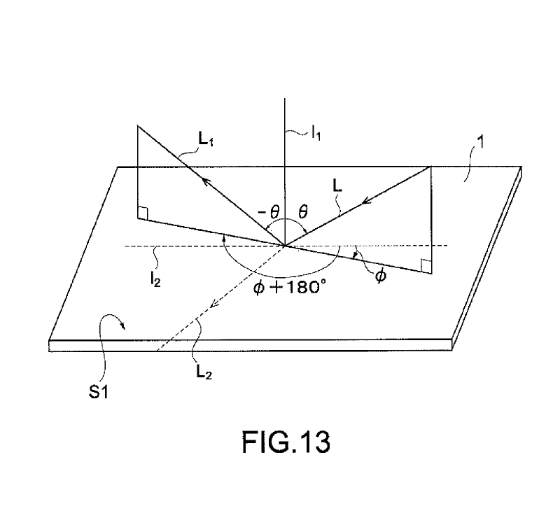

FIG. 13 is a perspective view showing the relationship between incident light entering the optical device 1 and light reflected by the optical device 1. The optical device 1 has an entrance surface S1 that is flat and on which the light is incident. The optical device 1 is configured to reflect light L₁ of a specific wavelength band in a direction other than a regular reflection direction (−θ, φ+180 degrees), and configured to have passed therethrough light L₂ of a wavelength band other than the specific wavelength band, as part of light L incident on the entrance surface S1 at an angle (θ, φ). The optical device 1 has transparency in light other than the specific light. It is preferable that the term “transparency” be used based on sharpness of transmissive mapping of optical comb which will be defined hereinafter. Here, the character “θ” is indicative of an angle between a line l₁ vertical to the entrance surface S1 and the light L incident on the entrance surface S1 or light L₁ reflected from the entrance surface. The character “φ” is indicative of an angle between a specific line l₂ on the entrance surface S1 and a projected component of the incident light L or the reflected light L₁ to the entrance surface S1. Here, the specific line l₂ on the entrance surface corresponds to an axis in which, when the optical device 1 is rotated with respect to the line l₁ vertical to the entrance surface S1, light reflected at an angle “φ” has maximum intensity. If there are two or more axes (directions) of maximum intensity, one of the axes is selected as a line l₂. Additionally, an angle “θ” of clockwise rotation with respect to line l₁ vertical to the entrance surface is shown by “+θ”, while an angle “θ” of counterclockwise rotation with respect to line l₁ vertical to the entrance surface is shown by “−θ”. An angle “φ” of clockwise rotation with respect to the line l₂ is shown by “−φ”, while an angle “φ” of counterclockwise rotation with respect to the line l₂ is shown by “−φ”.

Here, light of a specific wavelength band to be reflected in a specific direction and light to be passed through the optical device 1 vary depending on the intended use of the optical device 1. For example, when the optical device 1 is applied to the window unit 30, it is preferable that light of a specific wavelength band to be reflected in a specific direction may be near-infrared light, and the light to be passed through the optical device 1 may be visible light. More specifically, it is preferable that light of a specific wavelength band to be reflected in a specific direction may be mainly near-infrared light in the 780 nm to 2100 nm range. The optical device 1 can suppress the rise of room temperature resulting from light energy passing through the window from the sun under the condition that the optical device configured to reflect near-infrared light is attached to the window glass. Therefore, the optical device 1 can reduce load of air conditioner and achieve energy savings. Here, the “directional reflection” refers to reflection in a specific direction other than the direction of a regular reflection, and intensity which is sufficiently large in comparison with the intensity of non-directional reflection. Here, regarding reflection of light, it is preferable that reflectance in a specific wavelength band, for example, the range of near-infrared light be equal to or larger than 30%. As another preferable value, reflectance is equal to or larger than 50%. As further preferable value, reflectance is equal to or larger than 80%. Regarding transmission of light, it is preferable that transmittance in a specific wavelength band, for example, the range of visible light be equal to or larger than 30%. As another preferable value, transmittance is equal to or larger than 50%. As further preferable value, transmittance is equal to or larger than 70%.

It is preferable that the direction φ0 of specific light reflected by the optical device 1 attached to the window unit 30 be equal to or larger than −90 degrees, and equal to or smaller than 90 degrees, because the specific light forming part of light from the sky can be reflected to the sky. If there is no high-rise building in the neighborhood, the optical device 1 configured to reflect specific light in this direction is available. Further, It is preferable that specific light be reflected at an angle close to an angle of (θ, −φ). Here, it is preferable that deviation from an angle (θ, φ) be equal to or smaller than 5 degrees. As another preferable value, deviation from an angle (θ, φ) may be equal to or smaller than 3 degrees. As further preferable value, deviation from an angle (θ, φ) may be equal to or smaller than 2 degrees. When the optical device 1 is attached to the window unit 30, the optical device 1 can effectively reflect light of specific wavelength band in a specific direction, which forms part of light from the sky over buildings similar in height to each other and crammed side by side, to effectively return the light to the sky over nearby buildings. To realize such directional reflection, it is preferable to use, for example, part of spherical surface or hyperboloid, three-sided pyramid, four-sided pyramid, circular cone, or other three dimensional structure. When light is incident at an angle of (θ, φ) (−90 degrees<φ<90 degrees), light can be reflected at an angle of (θ0, φ0) (0 degrees<θ0<90 degrees, −90 degrees<φ0<90 degrees), or it is preferable to use cylinder extending in one direction. When light is incident at an angle of (θ, φ) (−90 degrees<φ<90 degrees), light can be reflected at an angle of (θ0, −φ) (0 degrees<θ0<90 degrees) based on the inclined angle of the cylinder.

It is preferable that a directional reflection of light of a specific wavelength to light incident on the entrance surface S1 at an incident angle (θ, φ) be close to a recursive reflection neighborhood direction or an angle (θ, φ). When the optical device 1 is attached to the window unit 30, the optical device 1 can reflect, to the sky, light of a specific wavelength to the sky, as part of light from the sky. Here, it is preferable that deviation from an angle (θ, φ) be equal to or smaller than 5 degrees. As another preferable value, deviation from an angle (θ, φ) may be equal to or smaller than 3 degrees. As further preferable value, deviation from an angle (θ, φ) may be equal to or smaller than 2 degrees. When the optical device 1 is attached to the window unit 30 in the range of those angles, the optical device 1 can effectively reflect light in a specific wavelength band to the sky, as part of light from the sky. When, for example, infrared light transmitter and receiver are closely arranged as in infrared light sensor, infrared image device, and the like, it is necessary that the recursive reflection neighborhood direction is the same as direction of incident light. In the present application, it is not necessary to sense light in a specific light. It is not necessary that the recursive reflection neighborhood direction is the same as direction of incident light.

It is preferable that a sharpness of a light-transmissive image of an optical comb of 0.5 mm, measured from light passed through the optical device, be equal to or larger than 50. As another preferable value, the sharpness of the light-transmissive image of the optical comb of 0.5 mm be equal to or larger than 60. As further preferable value, the sharpness of the light-transmissive image of the optical comb of 0.5 mm be equal to or larger than 75. On the other hand, when the sharpness of the light-transmissive image of the optical comb of 0.5 mm is smaller than 50, the light-transmissive image tends to be defocused. When the sharpness of the light-transmissive image of the optical comb of 0.5 mm is equal to or larger than 50, and smaller than 60, there is no problem with one's daily life even though the sharpness depends on external brightness. When the sharpness of the light-transmissive image of the optical comb of 0.5 mm is equal to or larger than 60, and smaller than 75, the user may be conscious of a diffraction pattern produced in response to an extremely bright object such as light source, but can look out the window in focus. When the sharpness of the light-transmissive image of the optical comb of 0.5 mm is equal to or larger than 75, the user is hardly conscious of the diffraction pattern. Further, it is preferable that the sum of the measured sharpness of the light-transmissive image of the optical combs of 0.125 mm, 0.5 mm, 1.0 mm, and 2.0 mm be equal to or larger than 230. As another preferable value, the sum may be equal to or larger than 270. As another preferable value, the sum may be equal to or larger than 350. When the sum is smaller than 230, the light-transmissive image tends to be defocused. When, on the other hand, the sum is equal to or larger than 230 and smaller than 270, there is no problem with one's daily life even though the sharpness depends on external brightness. When the sum is equal to or larger than 270 and smaller than 350, the user may be conscious of a diffraction pattern produced in response to an extremely bright object such as light source, but can look out the window in focus. When the sum is equal to or larger than 350, the user is hardly conscious of the diffraction pattern. Here, the sharpness of the light-transmissive image of the optical comb is measured on the basis of the Japanese Industrial Standards K-7105 by ICM-1T (produced by Suga Test Instruments Co., Ltd.). When light to be passed through the optical device 1 differs in wavelength from the light source D65, it is preferable that the sharpness be measured after being corrected by a filter corresponding to light to be passed through the optical device 1.

It is preferable that haze value be equal to or smaller than 6% in the wavelength range having transparency. As another preferable range, haze value may be equal to or smaller than 4%. As further preferable range, haze value may be equal to or smaller than 2%. When haze value is larger than 6%, the user feels that the sky seems to be cloudy, resulting from the fact that the transmitted light is scattered. Here, haze value has been measured by HM-150 (produced by MURAKAMI COLOR RESEARCH LABORATORY CO., Ltd.) on the basis of the measuring method defined by the Japanese Industrial Standards K-7136. When light to be passed through the optical device 1 differs in wavelength from the light source D65, it is preferable that haze value be measured after being corrected by a filter corresponding to light to be passed through the optical device 1. Further, the entrance place S1 of the optical device 1, or preferably both the entrance place S1 and the output surface S2 have flatness necessary to prevent the sharpness of the light-transmissive image of the optical comb from being deteriorated. Specifically, it is preferable that an arithmetic average Ra of roughness be equal to or smaller than 0.08 μm. As another preferable value, the arithmetic average Ra of roughness may be equal to or smaller than 0.06 μm. As further preferable value, the arithmetic average Ra of roughness may be equal to or smaller than 0.04 μm. Additionally, the above arithmetic average Ra of roughness is calculated through steps of measuring roughness of the entrance surface, obtaining roughness curve from two-dimensional cross-section curve, and calculating roughness parameter from the roughness curve. Measurement condition is based on the Japanese Industrial Standards B0601: 2001. The measurement instrument and the measurement condition are as follows:

Measurement Device:

Automatic Microfigure Measuring Instrument

SURFCORDER ET4000A (produced by Kosaka Laboratory Ltd.)

Measurement Condition:

λc=0.8 mm

estimation length: 4 mm

cutoff: ×5

data sampling interval 0.5 μm

It is preferable that light passed through the optical device 1 have almost neutral in color, even though there is such a thing as a colored optical device, light passed through the optical device 1 have sickly pastel color such as blue, blue green and green impressing the user favorably. In terms of producing favorable color, when, for example, the optical device 1 is exposed to irradiation from the light source D65, it is preferable that trichromatic coordinate (x, y) of light entered from the entrance surface S1, and transmitted through the optical layer 2 and the wavelength selective reflection layer 3, and output from the output surface S2 be 0.20<x<0.35, and 0.20<y<0.40. As another preferable range, 0.25<x<0.32, and 0.25<y<0.37. As further preferable range, 0.30<x<0.32, and 0.30<y<0.35. In terms of producing favorable color without being slightly reddish in color, it is preferable that y>x−0.02. As another preferable value, y>x. When the color of light reflected from the optical device 1 depends on the direction of the incident light, it is not preferable that the change in color of the optical device 1 applied to, for example, the window of a building is caused depending on a location of the window or a direction in which a person looks at the window while walking. In order to control the change in color of the optical device 1, it is preferable that light enters the entrance surface S1 or the output surface S2 at an angle “θ” equal to or larger than 0 degrees, and equal to or smaller than 60 degrees, the absolute value of the difference of chromatic coordinate “x” and the absolute value of the difference of chromatic coordinate “y” of light regularly reflected by the optical layer 2 and the wavelength selective reflection layer 3 be equal to or smaller than 0.05 in each principal surface of the optical device 1, as another preferable value, equal to or smaller than 0.03, as further preferable value, equal to or smaller than 0.01. It is preferable that the limitation of the numerical range about the chromatic coordinates “x” and “y” of the reflected light be satisfied in each of the entrance surface S1 and the output surface S2.

Heat Reflecting Window

In this embodiment, the optical device 1 is connected to the window unit 30 so that the embedding resin layer 12 is located on the input side of light (on the side of outside), and the shaped layer 11 is located on the output side of light. The second base member 22 is connected to the window unit 30 through the connection layer 23. An interface S1 between the connection layer 23 of the second base member 22 is flat, and formed as an input surface of light passed through the window unit 30. On the other hand, the surface S2 of the first base member 21 in contact with air is formed as an output surface of light passed through the optical device 1. The heat reflecting window 100 (window material) according to this embodiment is composed of the optical device 1, the connection layer 23, the window unit 30, and the like.

The connection layer 23 is formed of transmissive adhesive or pressure-sensitive adhesive, and formed of material the same in refraction index as the second base member 22 or/and the window unit 30. The optical device 1 can be improved in light loss by reflection at the interface and in transmittance.

In general, the window unit 30 is formed of various architectural or vehicular glass materials. However, the window unit 30 may be made of polycarbonate plate, acrylic plate, or various resin material. The window unit 30 may be composed of not only single-layered but also multilayered glass such as double glass.

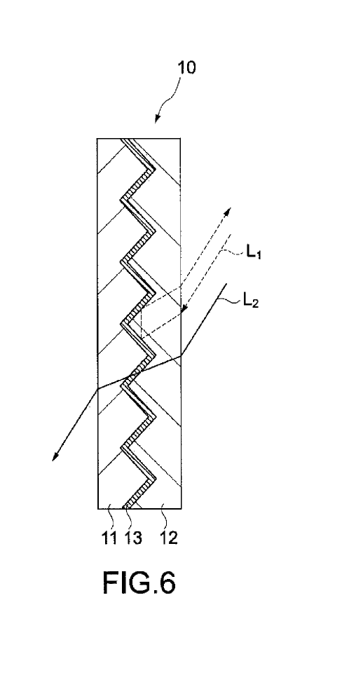

FIG. 6 is a schematic view for explaining an operation of the optical device 1 (laminated body 10). The optical device 1 is configured to reflect infrared light L1 which forms part of sunlight transmitted through a light entrance surface S1, and to have passed therethrough visible light L2 which forms part of sunlight transmitted through the light entrance surface S1 and output from a light output surface 2. The optical device 1 thus constructed can improve the visibility of the view from the window while suppressing the rise in temperature inside of the room or car.

In the optical device 1 according to the present embodiment, the optical function layer 13 is formed on the structures 11a, and recursively reflects infrared light (heat ray) L1 in a direction of incident light. Therefore, the optical device 1 can suppress the rise in temperature near the window unit 30 as compared to the case where the incident light is regularly reflected on the selective reflection layer.

In the optical device 1 according to the present embodiment, the embedding resin layer 12 functions as a layer configured to protect the structures 11a and the optical function layer 13. Therefore, the embedding resin layer 12 can protect the structures 11a and the optical function layer 13 from defacement and damage, and the optical device 1 can be improved in durability. Further, the thickness of the flat layer 12b is adjusted so that the ratio of the cubic volume (second cubic volume) of the flat layer 12b forming part of the embedding resin layer 12 to the cubic volume (first cubic volume) of the structured layer 12a forming part of the embedding resin layer 12 becomes equal to or larger than 5%. Therefore, it is possible to effectively absorb the residual stress of the resin formed as the embedding resin layer 12 cured by ultraviolet light. The optical device 1 can be improved in durability, and prevent the transmittance of the optical device 1 from being deteriorated by delamination between the optical function layer 13 and the structured layer 12a.

Manufacturing Method for Optical Device

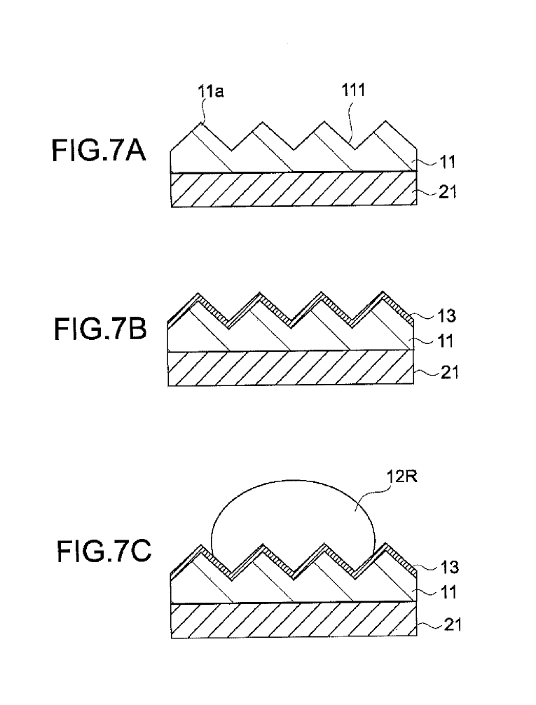

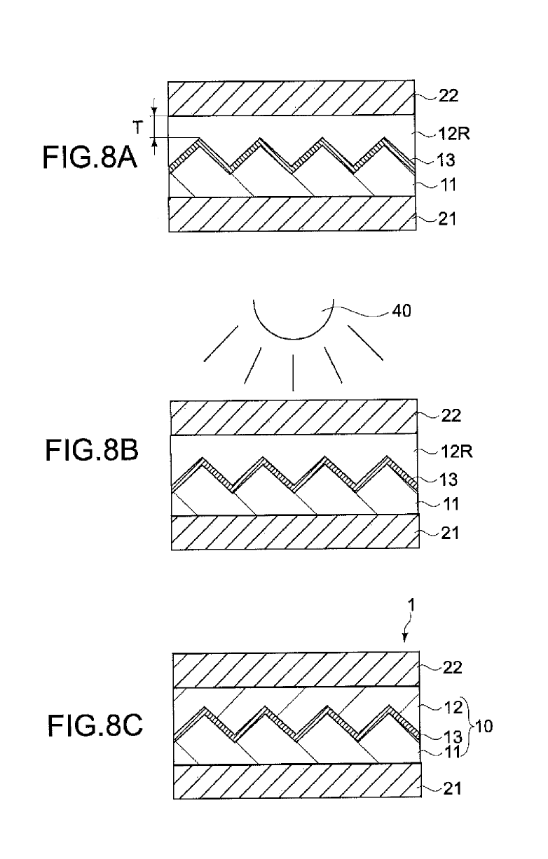

Hereinafter, a manufacturing method for the optical device 1 according to the present embodiment will be described. FIGS. 7 and 8 are schematic process charts for explaining steps of the manufacturing method for the optical device 1.

As shown in FIG. 7A, the shaped layer 11 having structures 11a is firstly formed. As an example of a method of forming the shaped layer 11, a mold tool having a patterned indented surface corresponding to the structures 11a is produced. The concave-convex shape of the mold tool Ultraviolet curable resin is then transcribed transferred from to ultraviolet curable resin the concave-convex shape of the mold tool. The base member 21 functions as a support to separate the mold tool from the ultraviolet curable resin transferred with the concave-convex shape. The shaped layer 11 is formed from ultraviolet curable resin through this process.

As shown in FIG. 7B, the optical function layer 13 is then formed on the structures 11a of the shaped layer 11. The optical function layer 13 is an optical multilayer film configured to reflect infrared light, and to have visible light passed therethrough. The optical function layer 13 is formed by a dry process such as sputtering method and vacuum deposition method. However, the optical function layer 13 may be formed by a wet process such as dip method, die coating method, and spray coating method.

As shown in FIG. 7C, a specific quantity of paste of uncured ultraviolet resin 12R is fed on the optical function layer 13 formed on the structures 11a. As shown in FIG. 8A, after the second base member 22 is stacked on the resin 12R in layers, the resin 12R is forced to be distributed throughout the entire area of the structures 11a of the shaped layer 11. In this process, the structures 11a and the optical function layer 13 are embedded in the ultraviolet curable resin 12R. Here, it is necessary to adjust a pressing force to change the distance “T” between the shaped layer 11 and the second base member 22 to a specific value.

The distance “T” between the shaped layer 11 and the second base member 22 corresponds to the thickness of the flat layer 12b (see FIG. 5), and this distance is adjusted so that the ratio of the cubic volume (second cubic volume) of the resin 12R in an area specified by this distance “T” to the cubic volume (first cubic volume) of the structured layer 12a becomes equal to or larger than 5%. It is possible to effectively suppress delamination of the optical function layer 13, resulting from residual stress of the structured layer 12a in the area of the concave section 111 of the shaped layer 12, in the process of curing the resin 12R.

As shown in FIG. 8B, the resin 12R is then subjected to, and cured by ultraviolet light from the ultraviolet lamp 40 through the second base member 22. The embedding resin layer 12 is formed through this process. As shown in FIG. 8C, the optical device 1 according to the present embodiment is produced through this process. The optical device 1 is not specifically limited in thickness, which is arbitrarily determined based on specification or application within, for example, a range from 50 μm to 300 μm.

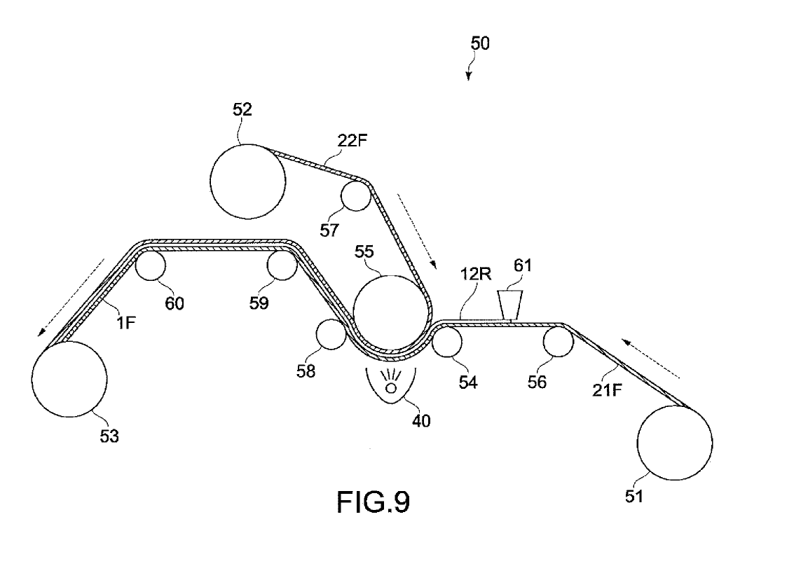

FIG. 9 is a schematic view showing a construction of an example of the manufacturing apparatus for the optical device 1. The manufacturing apparatus 50 shown in FIG. 9 has a first feeding roller 51 configured to feed a sheet-like first base member 21F, a second feeding roller 52 configured to feed a sheet-like second base member 22F, an application nozzle 61 configured to discharge ultraviolet curable resin 12R, and an ultraviolet lamp 40. As shown in FIG. 7B, the first base member 21F is configured to support the shaped layer 11 with the optical function layer 13. The second base member 22F corresponds to the second base member 22 shown in FIG. 8A. The manufacturing apparatus 50 further has a first laminating roller 54, a second laminating roller 55, and a winding roller 53. The first laminating roller 54 is made of rubber, while the second laminating roller 55 is made of metal.

The ultraviolet curable resin 12R is applied to the optical function layer 13 formed on the first base member 21 through an application nozzle 61. The first base member 21F and the second base member 22F are led by the guide rollers 56 and 57 into a gap between the laminating rollers 54 and 55 to produce a laminated film 1F so that the ultraviolet curable resin 12 is sandwiched between the first base member 21F and the second base member 22F. The ultraviolet resin layer 12R in the laminated film 1F is subjected to, and cured in response to ultraviolet light from the ultraviolet lamp 40. The winding roller 53 is configured to continuously wind the produced laminated film 1F. The laminated film 1F corresponds to the belt-like optical device 1 shown in FIG. 8C.

The manufacturing apparatus 50 thus constructed can continuously produce the optical device 1F, and enhance the productivity of the optical device 1F by using the first base member 21F and the second base member 22F. This optical device 1F is cut out on the basis of dimensions of the product.

The manufacturing apparatus 50 is not limited by the configuration shown in FIG. 9. For example, the ultraviolet lamp 40 may be located on the side of the second base member 22F to output ultraviolet light. The first base member 21F may be fed from the second feeding roller 52, and the second base member 22F may be fed from the first feeding roller 52.

As explained with reference to FIG. 8A, the laminating rollers 54 and 55 produce a laminated film 1F from ultraviolet curable resin 12R through a gap “T” between the first base member 21F (optical function layer 13) and the second base member 22F (22) placed in face-to-face relationship with each other. The gap “T” between the first base member 21F and the second base member 22F can be adjusted on the basis of viscosity of the ultraviolet curable resin 12R, tension of each of the first and second base members 21F and 22F, pressure applied to the second laminating roller 55 by the first laminating roller 54, and the like.

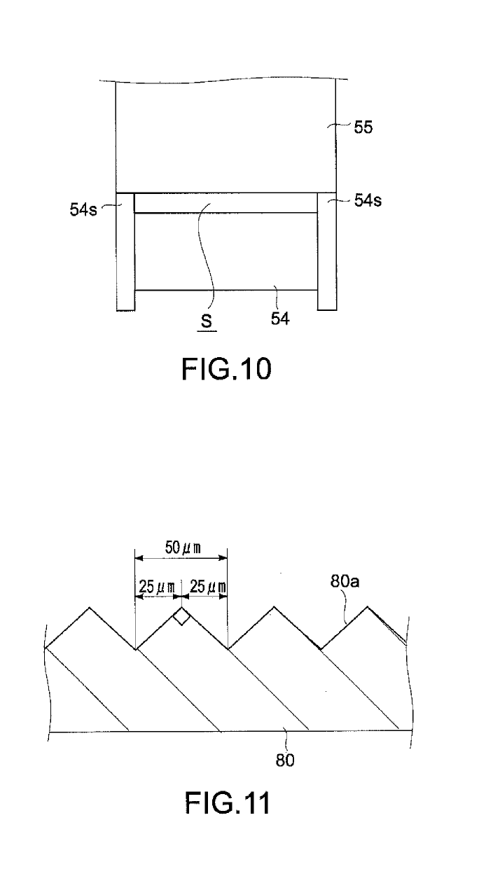

FIG. 10 is a plan view for explaining an example of a method of adjusting the gap “T”. In this example shown in FIG. 10, the gap “T” is maintained to form the laminated film 1F in a space “S” between the first laminating roller 54 and the second laminating roller 55. The space “S” is formed under the condition that flange-shaped spacers 54s formed at both ends of the first laminating roller 54 are brought into contact with the second laminating roller 55. The space “S”, i.e., the gap can be adjusted by elastic deformation of the spacers 54s and pressure applied to the second laminating roller 55 by the first laminating roller 54. Practical Examples

Hereinafter, practical examples of the optical device according to the embodiment will now be described. However, the present application is not limited to the following examples.

Optical device samples different from each other in type of ultraviolet curable resin of the embedding resin layer 12 and volume of the flat layer 12b of the embedding resin layer 12 have been produced, and then tested in temporal change of transmittance.

Prior to producing optical device samples, a mold tool 80 shown in FIG. 11 has been produced of Ni—P, and has a structure surface 80a formed with concave sections arranged successively. Each of the concave sections is a prism in shape, isosceles triangle in shape in cross-section, 50 μm in thickness (pitch of the concave sections), and 25 μm in depth. The apex angle of the prism-shaped concave sections is 90 degrees (angle necessary to effectively enhance its directional reflection property). The samples of the optical device 11 are classified into three groups respectively made of the following ultraviolet curable resins “A”, “B”, and “C” in fundamental composition. The shrinkage ratio of the resins “A”, “B”, and “C” are 3%, 8%, and 13% in volume, respectively.

Fundamental Composition of the Resin “A”

Urethane Acrylate (“ARONIX” produced by Toagosei Co., Ltd. (Registered Trademark of Toagosei Co., Ltd.)): 97 weight percent, and

Photopolymerization Initiator (“IRGACURE 184” produced by Nippon Kayaku Co., Ltd. (Registered Trademark of Ciba Holding Inc., Switzerland)): 3 weight percent.

Fundamental Composition of Resin “B”

Urethane Acrylate (“ARONIX” produced by Toagosei Co., Ltd.): 82 weight percent,

Cross-linking Agent (“T2325” produced by Tokyo Chemical Industry Co., Ltd.): 15 weight percent, and

Photopolymerization Initiator (“IRGACURE 184” produced by Nippon Kayaku Co., Ltd.): 3 weight percent.

Fundamental Composition of Resin “C”

Urethane Acrylate (“ARONIX” produced by Toagosei Co., Ltd.): 48.5 weight percent,

Cross-linking Agent (“T2325” produced by Tokyo Chemical Industry Co., Ltd.): 48.5 weight percent, and

Photopolymerization Initiator (“IRGACURE 184” produced by Nippon Kayaku Co., Ltd.): 3 weight percent.

### Example 1

The resin “B” was applied to the structure surface 80a of the mold tool 80, a 75 μm-thin film of polyethylene terephthalate (hereinafter simply referred to as “PET film”) (“COSMO SHINE A4300” produced by Toyobo Co., Ltd.) was formed on the resin “B” applied to the structure surface 80a. The resin “B” was then subjected to, and cured by ultraviolet light through the PET film. The laminated layer of the resin “B” and the PET film was then separated from the mold tool 80. The resin layer (shaped layer 11 (FIG. 7A)) having a structure surface provided with the arranged prism-shaped concave section 111 (FIG. 2) was produced through this process.

Then, alternating layers of a layer made of zinc oxide and a layer made of silver were then formed on the prism-shaped structure surface as the optical function layer. Here, the alternating layers of a zinc oxide layer of 35 nm in thickness, a silver layer of 11 nm in thickness, a zinc oxide layer of 80 nm in thickness, and a layer of 11 nm in thickness, and a zinc oxide layer of 35 nm in thickness were produced by the sputtering method.

After the resin “B” was applied to the optical function layer, a PET film (“COSMO SHINE A4300” produced by Toyobo Co., Ltd.) was formed on the resin “B”. This resin “B” was then subjected to, and cured by ultraviolet light through the PET film. The embedding resin layer 12 (FIG. 8C) was formed through this process.

The optical device samples produced through the above process were cut out on the basis of the dimensions of sample by a microtome at normal temperature. Then, cross-sectional images of those samples were then taken by an industrial microscope (produced by Olympus Corporation, OLS3000). Here, object lens magnification is 50 or 100. The optical device samples were then measured in thickness “T” (see FIG. 8A) of an area corresponding to the flat layer 12b (see FIG. 5) from those cross-sectional images by an image processor (produced by MITANI CORPORATION). In each sample, the ratio in volume of the flat layer to the corresponding concave section (hereinafter simply referred to as “volume ratio”) was calculated from the measured thickness “T”, and the results revealed that the volume ratio of each sample is 15%. Additionally, the volume ratio is adjustable to any value by the pressure for the lamination of the above PET film.

Each sample of the optical device was then measured in transmittance in the range of visible light (wavelength: 550 nm). In order to evaluate the change in transmittance of each sample, after a high-temperature and high-humidity test was carried out through 1500 hours in a constant temperature and humidity unit (temperature: 60 degrees Celsius, and relative humidity: 90%), each sample of the optical device was measured again in transmittance in the range of visible light (wavelength: 550 nm) by “V-7100” produced by JASCO Corporation.

### Example 2

A sample of the optical device having a flat layer having a volume ratio of 26% was produced in a manner the same as that of the example 1. The change of the transmittance of this sample was then measured under a specific condition the same as that of the example 1 before and after a high-temperature and high-humidity test.

### Example 3

A sample of the optical device having a flat layer having a volume ratio of 50% was produced in a manner the same as that of the example 1. The change of the transmittance of this sample was then measured under a specific condition the same as that of the example 1 before and after a high-temperature and high-humidity test.

### Example 4

A sample of the optical device having a flat layer having a volume ratio of 106% was produced in a manner the same as that of the example 1. The change of the transmittance of this sample was then measured under a specific condition the same as that of the example 1 before and after a high-temperature and high-humidity test.

### Example 5

A sample of the optical device having a flat layer having a volume ratio of 205% was produced in a manner the same as that of the example 1. The change of the transmittance of this sample was then measured under a specific condition the same as that of the example 1 before and after a high-temperature and high-humidity test.

### Example 6

A sample of the optical device having a flat layer having a volume ratio of 301% was produced in a manner the same as that of the example 1. The change of the transmittance of this sample was then measured under a specific condition the same as that of the example 1 before and after a high-temperature and high-humidity test.

### Example 7

A sample of the optical device having a flat layer having a volume ratio of 610% was produced in a manner the same as that of the example 1. The change of the transmittance of this sample was then measured under a specific condition the same as that of the example 1 before and after a high-temperature and high-humidity test.

### Example 8

In place of the resin “B”, a sample of the optical device having a flat layer having a volume ratio of 5% was produced from the resin “A” in a manner the same as that of the example 1. The change of the transmittance of this sample was then measured under a specific condition the same as that of the example 1 before and after a high-temperature and high-humidity test.

### Example 9

In place of the resin “B”, a sample of the optical device having a flat layer having a volume ratio of 50% was produced from the resin “C” in a manner the same as that of the example 1. The change of the transmittance of this sample was then measured under a specific condition the same as that of the example 1 before and after a high-temperature and high-humidity test.

### Example 10

In place of the resin “B”, a sample of the optical device having a flat layer having a volume ratio of 100% was produced from the resin “C” in a manner the same as that of the example 1. The change of the transmittance of this sample was then measured under a specific condition the same as that of the example 1 before and after a high-temperature and high-humidity test.

### Example 11

In place of the resin “B”, a sample of the optical device having a flat layer having a volume ratio of 204% was produced from the resin “C” in a manner the same as that of the example 1. The change of the transmittance of this sample was then measured under a specific condition the same as that of the example 1 before and after a high-temperature and high-humidity test.

### Example 12

In place of the resin “B”, a sample of the optical device having a flat layer having a volume ratio of 303% was produced from the resin “C” in a manner the same as that of the example 1. The change of the transmittance of this sample was then measured under a specific condition the same as that of the example 1 before and after a high-temperature and high-humidity test.

### Example 13

In place of the resin “B”, a sample of the optical device having a flat layer having a volume ratio of 612% was produced from the resin “C” in a manner the same as that of the example 1. The change of the transmittance of this sample was then measured under a specific condition the same as that of the example 1 before and after a high-temperature and high-humidity test.

### Comparative Example 1

A sample of the optical device having a flat layer having a volume ratio of 0% was produced in a manner the same as that of the example 1. The change of the transmittance of this sample was then measured under a specific condition the same as that of the example 1 before and after a high-temperature and high-humidity test.

### Comparative Example 2

A sample of the optical device having a flat layer having a volume ratio of 14% was produced in a manner the same as that of the example 1. The change of the transmittance of this sample was then measured under a specific condition the same as that of the example 1 before and after a high-temperature and high-humidity test.

### Comparative Example 3

In place of the resin “B”, a sample of the optical device having a flat layer having a volume ratio of 14% was produced from the resin “A” in a manner the same as that of the example 1. The change of the transmittance of this sample was then measured under a specific condition the same as that of the example 1 before and after a high-temperature and high-humidity test.

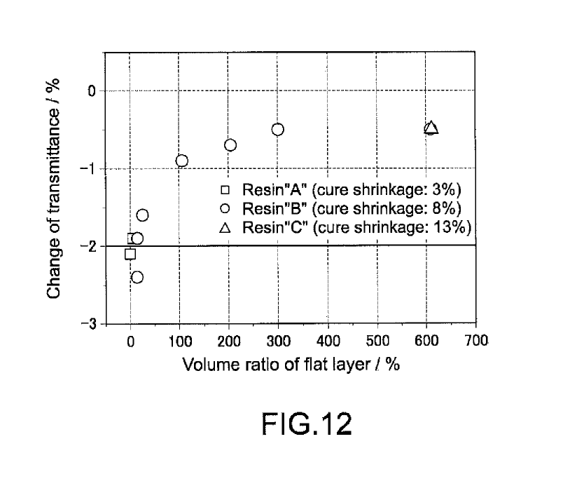

In each of the practical examples 1 to 13 and the comparative examples 1 to 3, the ratio in volume, transmittance measured before and after test, estimation on the basis of the change of transmittance are collectively shown in table 1. Each sample is estimated on the basis of whether or not the change of transmittance is equal to or larger than 2%. Here, in the estimation, the character “x” indicates that the relevant example is estimated as a failed example, and the character “O” indicates that the relevant example is estimated as a passed example. FIG. 12 is a graph showing the relationship between the ratio in volume of the flat layer and the change of the transmittance in the resins A to C.

| | | | | | | | Change of |
|---|---|---|---|---|---|---|---|
| | Ratio in volume of flat layer (%) | | | Measurement of transmittance (%) | | | transmittance |
| | Resin “A” | Resin “B” | Resin “C” | Before test | After test | Difference | (evaluation) |
| Comparative example 1 | | 0 | | 53.4 | 46.4 | −7.0 | × |
| Comparative example 2 | | 14 | | 53.1 | 50.7 | −2.4 | × |
| Practical example 1 | | 15 | | 53.2 | 51.3 | −1.9 | ○ |
| Practical example 2 | | 26 | | 53.2 | 52.2 | −1.0 | ○ |
| Practical example 3 | | 50 | | 53.5 | 52.3 | −1.2 | ○ |
| Practical example 4 | | 106 | | 53.5 | 52.4 | −1.1 | ○ |
| Practical example 5 | | 205 | | 53.1 | 52.4 | −0.7 | ○ |
| Practical example 6 | | 301 | | 53.5 | 53.0 | −0.5 | ○ |
| Practical example 7 | | 610 | | 53.4 | 52.9 | −0.5 | ○ |
| Comparative example 3 | 0 | | | 53.5 | 51.4 | −2.1 | × |
| Practical example 8 | 5 | | | 53.1 | 51.2 | −1.9 | ○ |
| Practical example 9 | | | 50 | 53.2 | 51.3 | −1.9 | ○ |
| Practical example 10 | | | 100 | 53.5 | 51.9 | −1.6 | ○ |
| Practical example 11 | | | 204 | 53.5 | 52.4 | −1.1 | ○ |
| Practical example 12 | | | 303 | 53.6 | 52.9 | −0.7 | ○ |
| Practical example 13 | | | 612 | 53.6 | 53.1 | −0.5 | ○ |

As will be seen from the table 1, each sample subjected to the high-temperature and high-humidity test drops to a lower value in transmittance in comparison with the relevant sample measured before the test. The drop in transmission results from delamination between the optical function layer and the embedding resin layer induced by residual stress of the embedding resin layer.

The optical device sample provided with the embedding resin layer made of the resin “A” can be suppressed to a value smaller than 2% in transmittance under the condition that this sample further has a flat layer based on the ratio of 5% or more in volume. On the other hand, the optical device sample provided with the embedding resin layer made of the resin “B” can be suppressed to a value smaller than 2% in transmittance under the condition that this sample further has a flat layer based on the ratio of 15% or more in volume. Further, the optical device sample provided with the embedding resin layer made of the resin “C” can be suppressed to a value smaller than 2% in transmittance under the condition that this sample further has a flat layer based on the ratio of 50% or more in volume. As will be seen from the above optical device samples, the optical device thus constructed can effectively suppress delamination between the embedding resin layer and the optical function layer resulting from residual stress of the ultraviolet curable resin, and is improved in durability.

While the present application has been described with relation to the preferred embodiment, the present application is not limited to the foregoing embodiment. And various modifications and adaptations thereof will be apparent to those skilled in the art as far as such modifications and adaptations fall within the scope of the appended claims intended to be covered thereby.

For example, in the foregoing embodiment, the optical function layer 13 is configured to reflect light in the range of infrared light, and to have visible light passed therethrough. However, the optical function layer 13 is not limited to that of the foregoing embodiment. For example, the wavelength band of light to be reflected by the optical device in the range of visible light, and the wavelength band of light to be passed through the optical device in the range of visible light may be set. The optical device according to the embodiment can function as a color filter.

The flat layer having thickness corresponding to the above gap “T” may be formed through steps of mixing ultraviolet resin layer for the embedding resin layer 12 with filler (spacer) with appropriate particle size. Hereinafter, modified examples of the above-mentioned embodiment will be described.

### Modified Example 1

For example, the optical function layer may function as a wavelength selective reflecting layer configured to reflect light in the range of specific wavelength band in a specific direction, as part of light incident on the entrance surface at an incidence angle (θ, φ), and to have passed therethrough light other than the light in the specific wavelength band. The optical function layer may function as a reflecting layer configured to reflect light incident on the entrance surface in a specific direction at an incidence angle (θ, φ), or may function as low scattering semi-transmissive layer having transparency to ensure that the user looks out the window through this device. As a reflection layer, the above metal layer may be used. It is preferable that the average thickness be 20 μm. As another preferable value, the average thickness may be equal to or smaller than 5 μm. As further preferable value, the average thickness may be equal to or smaller than 1 μm. When, on the other hand, the average thickness is larger than 20 μm, strained transmissive image tends to be caused by long light path in which the transmissive light is refracted. As a method of forming a reflection layer, sputtering method, vapor-deposition method, dip coating method, die coating method, and the like may be used.

On the other hand, for example, the semi-transmissive layer consists of single or multilayer of, for example, the above-mentioned metal layer. As material of the metal layer, material the same as that of the metal layer of the above-mentioned laminated film. Specific examples of the semi-transmissive layer are as follows:

(1) The reflection layer of AgTi: 8.5 nm (Ag/Ti=98.5/1.5 at %) is formed on the structured layer in the optical device according to the embodiment.

(2) The reflection layer of AgTi: 3.4 nm (Ag/Ti=98.5/1.5 at %) is formed on the structured layer in the optical device according to the embodiment.

(3) The reflection layer of AgNdCu: 14.5 nm (Ag/Nd/Cu=99.0/0.4/0.6 at %) is formed on the structured layer in the optical device according to the embodiment.

### Modified Example 2

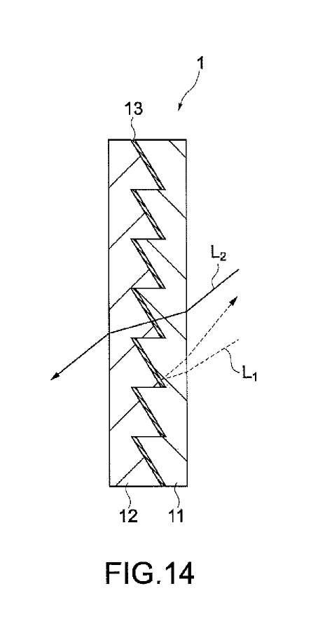

FIG. 14 is a cross-sectional view showing one example of the configuration of the optical device according to the modified example 2. The modified example 2 has a plurality of optical function layers 13 inclined with respect to the entrance surface of light, and formed between the structured layer and the embedding resin layer. The optical function layers 13 are arranged in parallel or substantially parallel to each other. In this example, as shown in FIG. 14, both the shaped layer 11 and the embedding resin layer 12 have light transmissive property, specific light L1 passed through the shaped layer 11 is reflected by the optical function layer 13 in a specific direction, while Light L2 other than the specific light is passed through the optical function layer 13. Here, the entrance surface of light may be defined on the side of the embedding resin layer 12. In this optical device 1, either the shaped layer 11 or the embedding resin layer 12 may have light transmissive property, and function to reflect incident light L1 in a specific direction, without having incident light L2 passed therethrough.

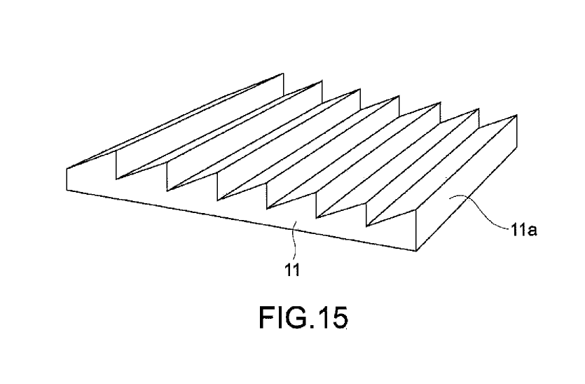

FIG. 15 is a perspective view showing one example of the configuration of the optical device according to the modified example. Each of the structures 11a is constituted by a convex section having the shape of triangular prism. The structures 11a, each of which is a triangular-prism-shaped convex section extending in one direction, are arrayed in another direction, and collectively form concave sections on a surface of the shaped layer 11. The structure 11a has a right-angled triangular shape in cross-section perpendicular to the extending direction thereof. The optical function layer 13 is formed on inclined surfaces of the structures 11a on the acute angle side of the structures 11a on the basis of a directional thin film forming method such as vapor-deposition method and sputtering method.

In this modified example, the optical function layers 13 are arranged in parallel relationship with each other. The number of reflection times in the optical function layer 13 can be reduced in comparison with the corner-of-cube-shaped or prism-shaped structures 11a. Therefore, the optical device 1 can enhance a reflection rate, and reduce the absorption of light in the optical function layer 13.

### Modified Example 3

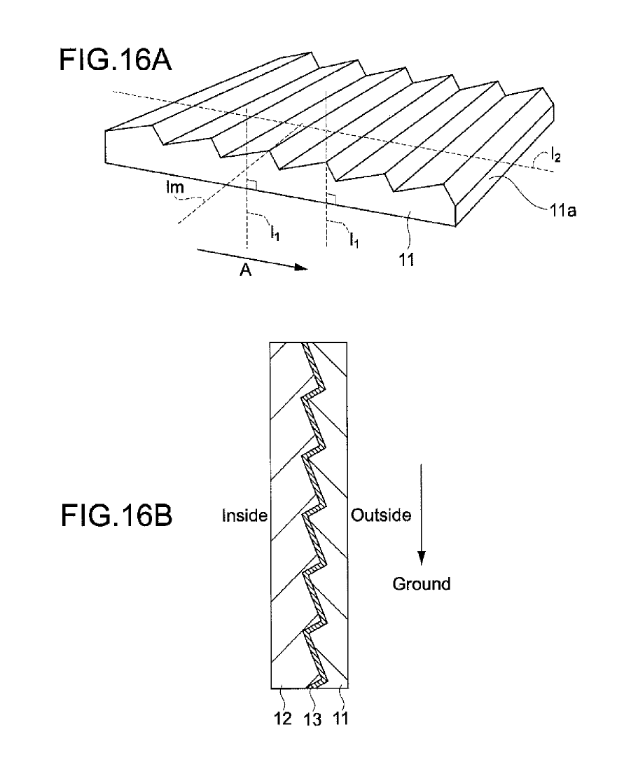

As shown in FIG. 16A, the structures 11a may have a shape asymmetrical to a vertical line l₁ perpendicular to the entrance surface or the output surface of the optical device 1. In this case, the principal axis lₘ of the structures 11a is inclined in an array direction A of the structures 11a with the vertical line l₁ as reference. Here, the principal axis lₘ of the structures 11a is intended to indicate a line which passes through the peak of the structures 11a, the center of the bottom line of the cross-section of the structures 11a. When the optical device 1 is attached to the window unit 30 located substantially perpendicular to the ground, as shown in FIG. 16B, it is preferable that the principal axis lₘ of the structures 11a be inclined with respect to the vertical line l₁ toward the ground. In general, heat flows into the room through the window, and the flow of heat reaches a peak in the early afternoon. In general, the height of the sun is larger than 45 degrees in the early afternoon. With the above-mentioned shape, the optical device 1 can effectively reflect light entering at large angles to the upward direction. As shown in FIGS. 16A and 16B, the prism shape of the structures 11a is unsymmetrical to the vertical line and the shape other than prism may be unsymmetrical to the vertical line l₁. For example, the corner-of-cube shape may be unsymmetrical to the vertical line l₁.

When the structures 11a have a shape of corner of cube, and the ridge R is large, it is preferable that the structures 11a be inclined in an upward direction, and in terms of suppressing reflection from a lower direction, the structures 11a be inclined in a downward direction. Light coming from the sun in the oblique direction with respect to the optical device hardly reaches deep sections of the optical device 1. The shape of the entrance side of the optical device 1 become of particular importance. When the ridge R is large, recursive reflection light is decreased. Therefore, it is preferable that the structures 11a be inclined in an upward direction in order to suppress the phenomenon above. In the corner of cube, recursive reflection is caused by light reflected three times on a reflection surface. On the other hand, part of light reflected two times is reflected in a direction other than recursive reflection. Most of the leaked light can be reflected to the sky direction by corner of cube inclined in a direction of the ground. Further, this may be inclined in any direction on the basis of the shape and utilization purpose.

### Modified Example 4

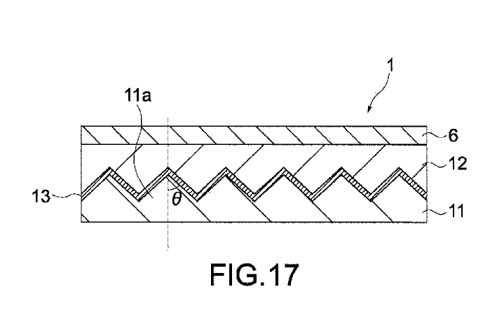

FIG. 17 is a cross-sectional view showing an example of the configuration of the optical device according to the modified example 4 of the present application. In this example, the optical device 1 according to the modified example further has a self-cleaning effect layer 6 having a self-cleaning effect on the entrance surface. For example, the self-cleaning effect layer 6 has photocatalyst such as TiO₂.

As described above, the optical device 1 is configured to partially reflect light in the specific wavelength band. When the optical device 1 is used in the open air outside or in a filthy room, scattering of light caused by dirt on the surface of the optical device 1 deteriorates the partial reflection characteristics (for example, directional reflection characteristic). Therefore, it is preferable that the surface of the optical device 1 be optically transmissive at all times, and the surface of the optical device 1 be excellent in water-repellent property and hydrophilic property, and exert a self purification effect.

In this modified example, the entrance surface of the optical device 1 is provided with a water repellent function, a hydrophilic function, and the like, by reason that the self-cleaning function layer 6 is formed on the entrance surface of the optical device 1. Therefore, the optical device 1 can prevent contamination of the entrance surface, deterioration of partially-reflection property (for example, directional reflection property).

### Modified Example 5

This modified example is different from the above embodiment in terms of the fact that the optical device 1 is configured to reflect light of a specific wavelength band in a specific direction, and to scatter light other than the light of the specific wavelength band. The optical device 1 has a light scattering member configured to scatter incident light. For example, the light scattering member is provided on, at least, the surface or inside of the shaped layer or the embedding resin layer, or between the optical function layer and the shaped layer or the embedding resin layer. When the optical device 1 is attached to the window material or the like, the optical device 1 can be attached to the window material on the inside or outside of a building. When the optical device 1 is attached to the window material on the outside of a building, it is preferable that a light scattering member configured to scatter light in the range other than the specific range be provided only between the optical function layer 13 and the window unit 30 or the like. When the optical device 1 is attached to the window material or the like, light scattering member existing between the optical function layer 13 and the entrance surface deteriorates the directional reflection characteristic. When the optical device 1 is attached to the inner surface of the window material, it is preferable that light scattering member be provided between the output surface of the window material and the optical function layer 13.

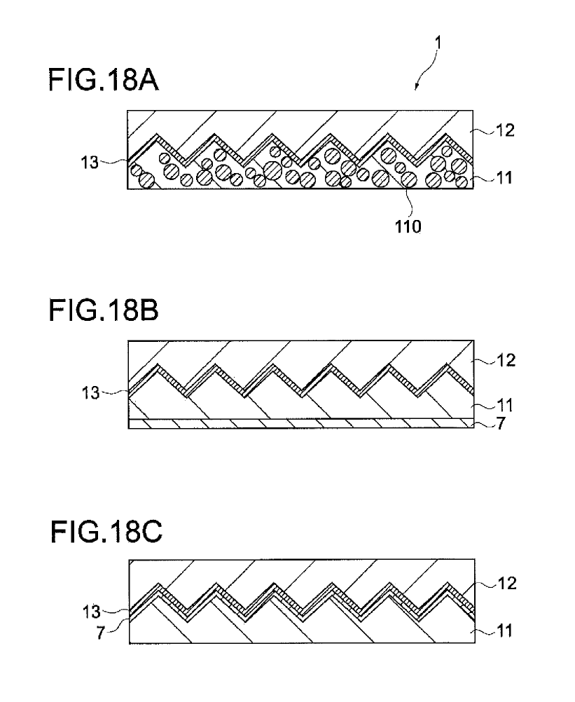

FIG. 18A is a cross-sectional view showing the first construction of the optical device according to the modified example. As shown in FIG. 18A, the shaped layer 11 has resin and fine particles 110. The fine particles 110 are different in refraction index from resin of the primary component of the shaped layer 11. The fine particles 110 may be composed of, for example, either or both organic and inorganic particles. Further, the fine particles 110 may be composed of hollow particles, and composed of inorganic particles made of silica, alumina or the like, or organic particles made of styrene, acrylic, their copolymer, or the like. Optimally, the fine particles 110 are made of silica.

FIG. 18B is a cross-sectional view showing the second construction of the optical device according to the modified example. As shown in FIG. 18B, the optical device 1 further includes a light diffusion layer 7 on the rear surface of the shaped layer 11. The light diffusion layer 7 has, for example, resin and fine particles which may be the same as those of the first construction.

FIG. 18C is a cross-sectional view showing the third construction of the optical device according to the modified example. As shown in FIG. 18C, the optical device 1 further includes a light diffusion layer 7 intervening between the optical function layer 13 and the shaped layer 11. The light diffusion layer 7 has, for example, resin and fine particles which may be the same as those of the first construction.

The modified example of the optical device can reflect light in the range of infrared light or specific light, and scatter visible light and the like other than the specific light. As an industrial design, the optical device 1 is composed of smoked optical device.

### Modified Example 6

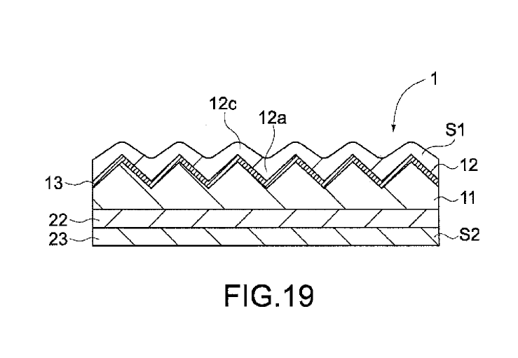

In the above embodiment, the embedding resin layer 12 of the optical device 1 has a flat layer 12b. However, as shown in FIG. 19, the optical device 1 according to this modified example has an entrance surface Si consisting of a concavo-convex layer 12c. For example, it is preferable that the concavo-convex shape of the entrance surface S1 correspond to the concavo-convex shape of the shaped layer 11, the entrance surface S1 correspond to the shaped layer 11 in each of the top of the convex section and the lowest part of the concave section, or the concavo-convex shape of the entrance surface S1 be milder than the concavo-convex shape of the first optical layer 4.

Here, the concave-and-convex layer 12c corresponds to the second layer formed on the structured layer (first layer) 12a having the second volume, the ratio of the second volume to the first volume of the structured layer 12a is equal to or larger than 5%. For example, the structures and the optical function layer are embedded by the embedding resin layer 12 consisting of the structured layer 12a and the concave-and-convex layer 12c made of the energy beam curable resin.

### Modified Example 7

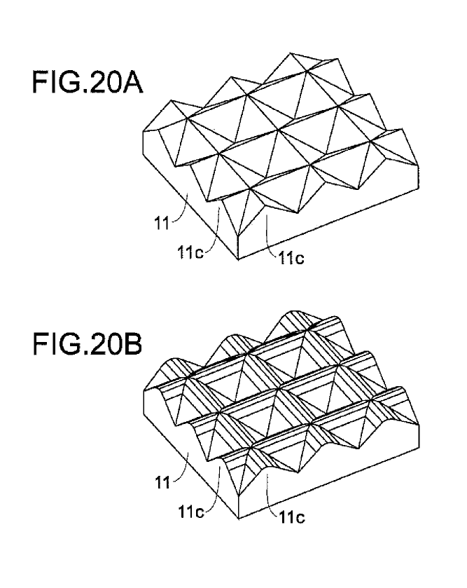

FIGS. 20 to 22 are cross-sectional views showing modified examples of the structure of the optical device according to the embodiment.

In one mode of this modified example, as shown in FIGS. 20A and 20B, for example, orthogonally-arranged columnar structures (columnar object) 11c are formed on one principal surface of the shaped layer 11. More specifically, the first structures 11c arranged in the first direction pass through side surfaces of the second structures 11c arranged in the second direction perpendicular to the first direction, while the second structures 11c arranged in the second direction pass through side surfaces of the first structures 11c arranged in the first direction. The columnar structure 11c is a concave or convex section having for example prism, lenticular, or columnar shape.

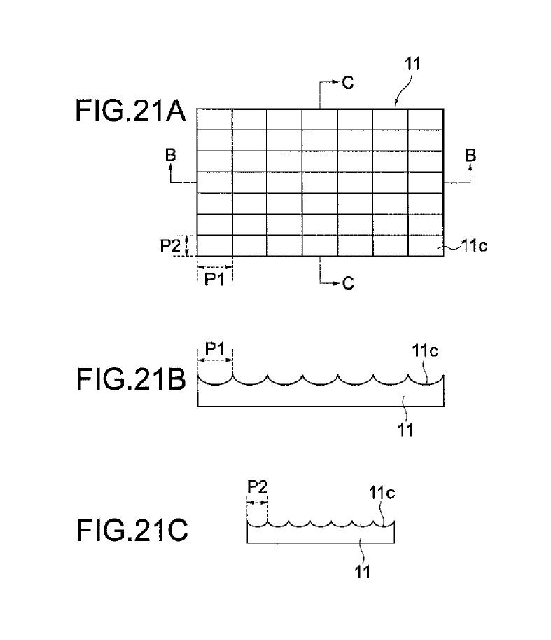

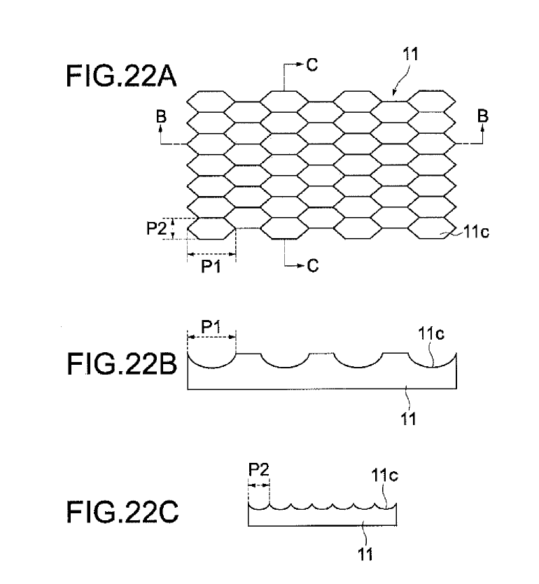

For example, it is possible to two-dimensionally arrange structures 11c, each of which has the shape of spherical, corner of cube or the like, on one principal surface of the shaped layer 11 to form close-packed array such as regular close-packed array, delta close-packed array, and hexagonal close-packed array. Regarding regular closed-packed array, as shown in FIGS. 21A to 21C, the structures 11c, each of which has a quadrangular-shaped (for example square-shaped) bottom surface are arranged in the form of regular closed-packed structure. Regarding hexagonal close-packed array, as shown in FIGS. 22A to 22C, the structures 11c, each of which has a hexagonal-shaped bottom surface are arranged in the form of hexagonal close-packed structure.

In the following, the description will be made of application examples of the present application.

Although in the above-mentioned embodiments, the case where the optical device according to the embodiment is applied to the window material or the like has been described as an example, the optical device according to the embodiment may be applied to an interior member, an exterior member, or the like other than the window material. As the above-mentioned members, there are exemplified not only a fixed member such as a wall or a roof, but also a member capable of changing an application amount of the optical unit depending on needs for change in season, time, or the like. There is exemplified a member capable of adjusting transmittance of incident light to the optical unit, for example, a window shade in such a manner that the optical unit is divided into a plurality of elements, and the angle thereof is changed. Further, there is exemplified a member capable of being wound or fold, to which the optical unit is applied, for example, a rolling curtain. In addition, there is exemplified a member with the optical unit being fixed to a frame, which allows the member to be removable for each frame depending on needs, for example, a paper door.

As the interior member or the exterior member, to which the optical device is applied, there are exemplified an interior member or an exterior member constituted of the optical device itself, and an interior member or an exterior member constituted of a transparent base material onto which the optical device is bonded. When the interior member or the exterior member as described above is installed in vicinity of a window in a room, it is possible to reflect only infrared light in a specific direction out of the room and to take visible light into the room, for example. Thus, even in a case where the interior member or the exterior member is installed, it is possible to reduce a need for room lighting. Further, there is little diffuse reflection into the room through the interior member or the exterior member, and hence it is also possible to suppress an increase of an ambient temperature. Further, it is also possible to apply bonded members other than the transparent base material, depending on an object necessary for controlling visibility, enhancing the strength, or the like.

### Application Example 1

In this application example, the description will be made of a sun screening apparatus (window shade apparatus) capable of adjusting a screening amount of the incident light by a sun screening member group constituted of a plurality of sun screening members, through changing the angle of the sun screening member group.

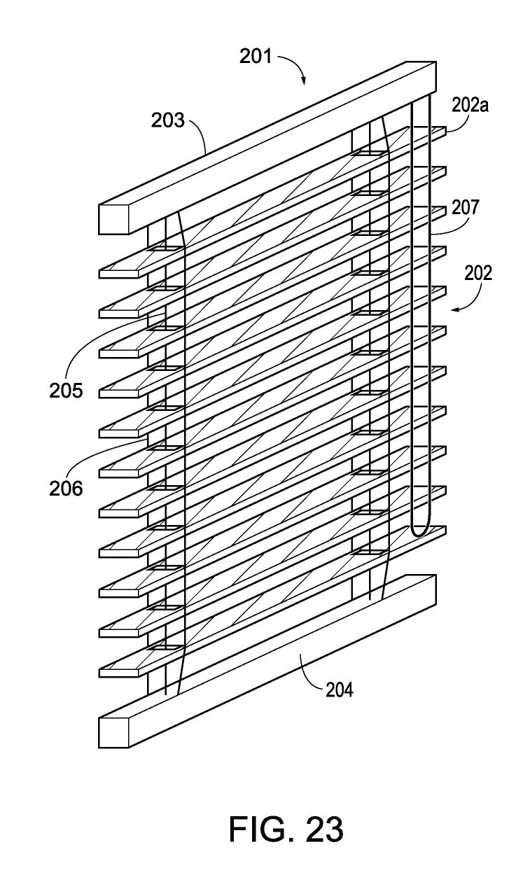

FIG. 23 is a perspective view showing an example of a configuration of a window shade apparatus according to the application example. As shown in FIG. 23, a window shade apparatus 201 serving as the sun screening apparatus includes a head box 203, a slat group (sun screening member group) 202 constituted of a plurality of slats (blades) 202a, and a bottom rail 204. The head box 203 is provided above the slat group 202 constituted of the plurality of slats 202a. From the head box 203, a ladder code 206 and a lift cord 205 extend downwardly. The bottom rail 204 is suspended from lower ends of those cords. The slats 202a serving as the sun screening members each have an elongated rectangular shape, for example, and are supported in predetermined intervals through the ladder code 206 downwardly extending from the head box 203. Further, the head box 203 is provided with an operation means (not shown) such as a rod for adjusting the angle of the slat group 202 constituted of the plurality of slats 202a.

The head box 203 serves as a driving means for rotationally driving the slat group 202 constituted of the plurality of slats 202a in response to operation of the operation means such as the rod, to thereby adjust the amount of light entering a space such as a room. Further, the head box 203 also has a function as a driving means (lifting and lowering means) for lifting and lowering the slat group 202 appropriately in response to operation of an operation means such as a lifting and lowering operation cord 207.

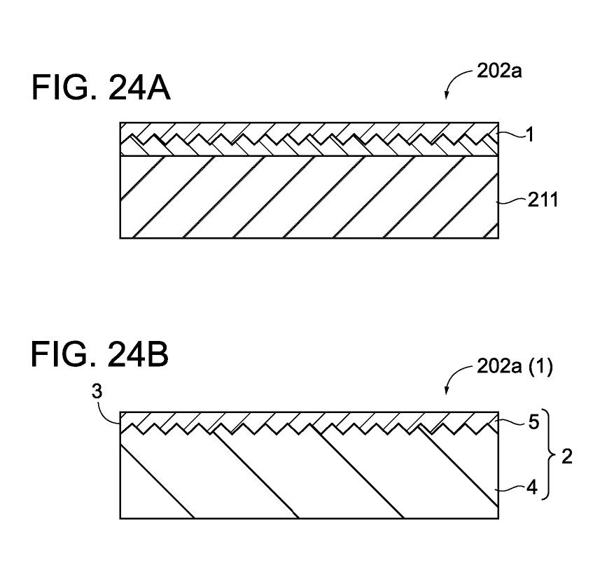

FIG. 24A is a cross-sectional view showing a first configuration example of one of the slats. As shown in FIG. 24A, the slat 202a includes a base material 211 and an optical film 1. Preferably, the optical film 1 is provided on an incident surface side (for example, surface side opposed to window material) of both principal surfaces of the base material 211, which external light is allowed to enter in a state in which the slat group 202 is closed. The optical film 1 and the base material 211 are bonded to each other through an adhesive layer, for example.

The shape of the base material 211 may include, for example, a sheet-shape, a film shape, and a plate-shape. As the material for the base material 211, glass, a resin material, paper material, and cloth material can be used. In view of the fact that visible light is allowed to enter a predetermined space such as a room, it is preferred to use a resin material having a transparency as the material for the base material 211. As the glass, the resin material, the paper material, and the cloth material, publicly known materials as the materials for the roll screen in related art can be used. As the optical film 1, one type of the optical films 1 according to the first embodiment to the sixth embodiment can be used. Otherwise, it is also possible to use combination of two or more types of the optical films 1 according to the first embodiment to the sixth embodiment can be used.

FIG. 24A is a cross-sectional view showing a second configuration example of one of the slats. As shown in FIG. 24B, in the second configuration example, the optical film 1 is used as the slat 202a. Preferably, the optical film 1 can be supported through the ladder cord 206, and has such rigidity that the optical film 1 is capable of keeping the shape thereof when supported.

It should be noted that, although in the application example, the example in which the present application is applied to the horizontal type window shade apparatus (Persian window shade apparatus) has been described, the present application is also applicable to a vertical type window shade apparatus (vertical window shade apparatus).

### Application Example 2

In this application example, the description will be made of a roll screen apparatus as an example of the sun screening apparatus capable of adjusting the screening amount of the incident light by the sun screening members, through winding up or winding off the sun screening members.

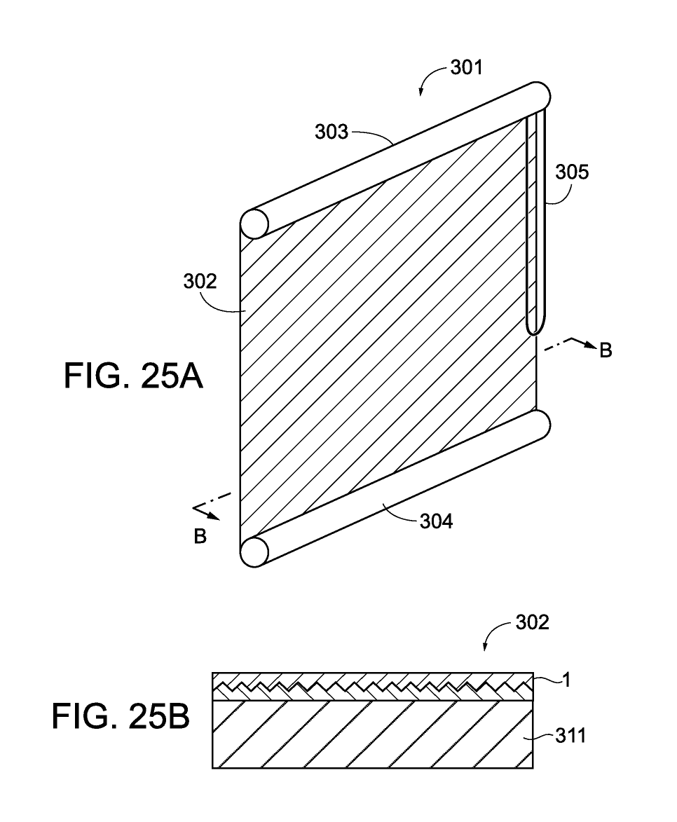

FIG. 25A is a perspective view showing an example of a configuration of the roll screen apparatus according to the application example. As shown in FIG. 25A, the roll screen apparatus 301 serving as the sun screening apparatus includes a screen 302, a head box 303, and a core 304. The head box 303 is configured to lift and lower the screen 302 when operated through an operation portion such as a chain 305. The head box 303 includes a winding axis for winding the screen into head box 303 and winding off. To the winding axis, one end of the screen 302 is connected. Further, to the other end of the screen 302, the core 304 is connected. The screen 302 has flexibility. The shape of the screen 302 is not particularly limited. It is preferred to select the shape of the screen 302 depending on the shape of the window material or the like, to which the roll screen apparatus 301 is applied. For example, a rectangular shape may be selected.

FIG. 25A is a cross-sectional view showing an example of a configuration of the screen 302. As shown in FIG. 25B, the screen 302 includes a base material 311 and the optical device 1, and preferably the screen 302 has flexibility. Preferably, the optical device 1 is provided on an incident surface side (for example, surface side opposed to window material), which external light is allowed to enter, of both principal surfaces of the base material 311. The optical device 1 and the base material 311 are bonded to each other, for example, through an adhesive layer or the like. It should be noted that the configuration of the screen 302 is not limited to the above-mentioned example, and the optical device 1 may be used as the screen 302.

The shape of the base material 311 may include, for example, a sheet-shape, a film shape, and a plate-shape. As the material for the base material 311, glass, a resin material, paper material, and cloth material can be used. In view of the fact that visible light is allowed to enter a predetermined space such as a room, it is preferred to use a resin material having a transparency as the material for the base material 311. As the glass, the resin material, the paper material, and the cloth material, publicly known materials as the material for the roll screen in related art can be used. As the optical device 1, one type of the optical devices 1 according to the above-mentioned embodiments or the modified examples can be used. Otherwise, it is also possible to use combination of two or more types of the optical devices 1 according to the above-mentioned embodiments or the modified examples can be used.

It should be noted that although in the application example, the roll screen apparatus has been described, the present application is not limited to that example. For example, the present application is also applicable to the sun screening apparatus capable of adjusting the screen amount of the incident light by the sun screening members, through folding up the sun screening members. As the above-mentioned sun screening apparatus, there can be exemplified a pleated screen apparatus adjusting the screening amount of the incident light through folding up the screen serving as the sun screening member in a bellows form, for example.

### Application Example 3

In this application example, the description will be made of an example in which the present application is applied to a fitting (interior member or exterior member), which includes a light entrance portion in the optical device having a performance of reflecting light in a specific direction.

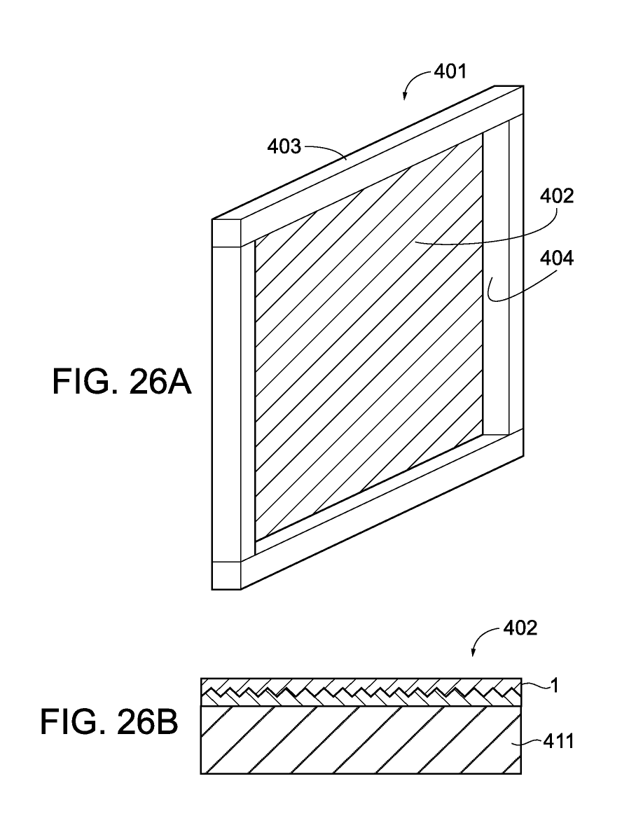

FIG. 26A is a perspective view showing an example of a configuration of a fitting according to an application example. As shown in FIG. 26A, the fitting 401 has such a configuration that an optical unit 402 is provided in the light entrance portion 404. Specifically, the fitting 401 includes an optical unit 402 and a frame material 403 provided in a peripheral portion of the optical unit. The optical unit 402 is fixed through the frame material 403. Further, the optical unit 402 is removable through disassembling the frame material 403 depending on needs. Although the fitting 401 may include, for example, a paper door, the present application is not limited to that example and is also applicable to various fittings including the light entrance portion.

FIG. 26B is a cross-sectional view showing an example of a configuration of the optical unit. As shown in FIG. 26B, the optical unit 402 includes a base material 411 and an optical device 1. The optical device 1 is provided on an incident surface side (for example, surface side opposed to window material), which external light is allowed to enter, of both principal surfaces of the base material 411. The optical device 1 and the base material 411 are bonded to each other, for example, through an adhesive layer or the like. It should be noted that the configuration of the paper door 401 is not limited to the above-mentioned example, and the optical device 1 may be used as the optical unit 402.

The base material 411 is a sheet, a film, or a substrate, for example, which has flexibility. As the material for the base material 411, glass, a resin material, paper material, and cloth material can be used. In view of the fact that visible light is allowed to enter a predetermined space such as a room, it is preferred to use a resin material having a transparency as the material for the base material 411. As the glass, the resin material, the paper material, and the cloth material, publicly known materials as the material for the optical device of the fitting in related art can be used. As the optical device 1, one type of the optical devices 1 according to the above-mentioned embodiments or the modified examples can be used. Otherwise, it is also possible to use combination of two or more types of the optical devices 1 according to the above-mentioned embodiments or the modified examples can be used.

It should be noted that, although in the above-mentioned application example, the examples in which the present application is applied to the interior member or the exterior member such as the window material, the fitting, the slats of the window shade apparatus, or the screen of the roll screen apparatus has been described, the present application is not limited to the above-mentioned examples, and is also applicable to an interior members and an exterior members other than the above-mentioned interior or exterior members.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. An optical device, comprising:
a shaped layer having a structure forming a concave section;
an optical function layer formed on the structure, and configured to reflect incident light of a particular frequency range and transmit incident light of other frequency ranges; and
an embedding resin layer made of energy beam curable resin, the embedding resin layer being configured to have a first layer having a first volume and a second layer having a second volume and being formed on the first layer, a ratio of the second volume to the first volume being equal to or larger than 5%, the concave section being completely filled with the first layer, the first layer having a continuously flat surface facing the second layer, the structure and the optical function layer being embedded in the embedding resin layer, and at least one of the shaped layer and the embedding resin layer having light transmissive property and an entrance surface for the incident light;
wherein the transmitted incident light passes through each of the shaped layer, optical function layer, and embedding resin layer.

2. The optical device according to claim 1, wherein
the energy beam curable resin has a cure shrinkage ratio equal to or larger than 8% in volume, and
the ratio of the second volume to the first volume is equal to or larger than 15% in volume.

3. The optical device according to claim 1, wherein
the energy beam curable resin has a cure shrinkage ratio equal to or larger than 13% in volume, and
the ratio of the second volume to the first volume is equal to or larger than 50%.

4. The optical device according to claim 1, further comprising:
a base member formed on at least one of the shaped layer and the embedding resin layer, the base member having light-transmissive property.

5. The optical device according to claim 1, wherein
the optical function layer is a wavelength-selective reflection layer.

6. The optical device according to claim 5, wherein
the wavelength-selective reflection layer is configured to reflect infrared light in a desired direction and to have visible light passed therethrough.

7. The optical device according to claim 5, which is configured to reflect light of a first wavelength band, from the optical function layer, in a direction other than a regular reflection direction (−θ, φ+180 degrees), the direction other than the regular reflection direction being based on a configuration of the optical function layer, and configured to have passed therethrough light of a second wavelength band different from the first wavelength band, as part of light incident on the entrance surface at an angle (θ, φ), wherein
“θ” is indicative of an angle between a line vertical to the entrance surface and the light incident on the entrance surface or light reflected from the entrance surface, and
“φ” is indicative of an angle between a specific line on the entrance surface and a projected component of the incident light or the reflected light to the entrance surface, the specific line being orthogonal to the vertical line.

8. The optical device according to claim 5, wherein
the entrance surface is a flat surface.

9. The optical device according to claim 5, wherein
a sharpness of a light-transmissive image measured with respect to an optical comb of 0.5 mm, and measured from light passed through the optical device, is equal to or larger than 50%.

10. The optical device according to claim 5, wherein
a sum of sharpness of light-transmissive images measured with respect to optical combs of 0.125 mm, 0.5 mm, 1.0 mm, and 2.0 mm, and measured from light passed through the optical device, is equal to or larger than 230%.

11. The optical device according to claim 1, wherein
the optical function layer is a semi-transmissive layer.

12. The optical device according to claim 1, wherein
the optical function layer includes a plurality of optical function layers inclined with respect to the entrance surface, the plurality of optical function layers being arranged parallel to each other.

13. The optical device according to claim 1, wherein
a difference in refraction index between the shaped layer and the embedding resin layer is equal to or larger than 0.010.

14. The optical device according to claim 1, wherein
the structure has a shape of prism, cylinder, hemisphere, or corner of a cube.

15. The optical device according to claim 1, wherein
the structure is arranged as one or two-dimensional structure and has a main axis inclined in an array direction of the structure with respect to a perpendicular line of the entrance surface.

16. The optical device according to claim 1, wherein
when the incident light entering through one surface of the optical device has trichromatic coordinates “x” and “y”, an absolute value of a difference of each of the chromatic coordinates “x” and “y” (i) entered through one of surfaces of the optical device, and (ii) regularly reflected by the optical device, is equal to or smaller than 0.05 in each of the surfaces of the optical device, wherein an incident angle of the light that entered is equal to or larger than 5 degrees, and equal to or smaller than 60 degrees.

17. The optical device according to claim 1, further comprising:
one of a water-shedding layer or a hydrophilic layer on the entrance surface of the optical device.

18. A sun-screening apparatus, comprising:
one or more sun-screening members configured to screen sunlight, the sunscreening members having the optical device according to claim 1.

19. A fitting, comprising:
a lighting section provided with the optical device according to claim 1.

20. A window material, comprising:
a first retainer configured to have a structure forming a concave section;
an optical function layer formed on the structure, and configured to reflect incident light of a particular frequency range and transmit incident light of other frequency ranges;
a second retainer made of energy beam curable resin, the second retainer being configured to have a first layer having a first volume, and a second layer formed on the first layer, the second layer being configured to have a second volume, the concave section being completely filled with the first layer, the first layer having a continuously flat surface facing the second layer, a ratio of the second volume to the first volume being equal to or larger than 5%, and the structure and the optical function layer being embedded in the second retainer; and
a window unit connected to the second retainer,
wherein the transmitted incident light passes through each of the first retainer, the optical function layer, and the second retainer.

21. A manufacturing method for an optical device, comprising:
forming a first retainer configured to have a structure forming a concave section;
forming an optical function layer formed on the structure, and configured to reflect incident light of a particular frequency range and transmit incident light of other frequency ranges; and
forming a second retainer configured to have a first layer having a first volume, and a second layer formed on the first layer, the second layer being configured to have a second volume, the concave section being completely filled with the first layer, the first layer having a continuously flat surface facing the second layer, and a ratio of the second volume to the first volume being equal to or larger than 5%, by embedding the structure and the optical function layer in energy beam curable resin,
wherein the optical device is further configured to transmit the transmitted incident light through each of the first retainer, the optical function layer, and the second retainer.
